(19) United States
(12) Patent Application Publication
(10) Pub. No.: US 2009/0048789 A1
(43) Pub. Date: Feb. 19, 2009

(54) Optimized Embedded Ultrasonics Structural Radar System With Piezoelectric Wafer Active Sensor Phased Arrays For In-Situ Wide-Area Damage Detection

(75) Inventors: Lingyu Yu, Columbia, SC (US); Victor Giurgiutiu, Columbia, SC (US)

Correspondence Address: DORITY & MANNING, P.A., POST OFFICE BOX 1449, GREENVILLE, SC, 29602-1449, US

(73) Assignee: University of South Carolina, Columbia, SC (US)

(21) Appl. No.: 12/101,447

(22) Filed: Apr. 11, 2008

Related U.S. Application Data
(60) Provisional application No. 60/923,292, filed on Apr. 13, 2007.

(51) Int. Cl. G01B 5/28; G01N 29/04

(52) U.S. Cl. 702/39; 73/625

(57) ABSTRACT

The present subject matter is direct to apparatus and methodologies for performing omnidirectional (360°) damage detection in a thin-wall structure using a planar embedded piezoelectric wafer active sensors (PWAS) phased array. Virtual beamforming for the array is implemented through either a transmission process by selective energizing selected sensors or by a signal post-processing procedure. Sensors may be embedded in a thin-walled structure as planar or circular arrays to achieve omnidirectional damage detection.

### PRIORITY

Priority is claimed to U.S. Provisional Application 60/923,292 entitled “Optimized Embedded Ultrasonics Structural Radar System with Piezoelectric Wafer Active Sensor Phased Arrays for In-Situ Wide-Area Damage Detection,” filed on Apr. 13, 2007.

### GOVERNMENT SUPPORT CLAUSE

The present invention was developed with funding from National Science Foundation Grants CMS-0408578 and CMS-0528873 and from Air Force Office of Scientific Research Grant FA9550-04-0085. Therefore, the government retains certain rights in this invention.

### FIELD OF THE INVENTION

The present subject matter relates to fault detection. More specifically, the present subject matter relates to systems and methodologies for detecting structural faults is in thin walled structures using nondestructive ultrasound techniques.

### BACKGROUND OF INVENTION

The principles and applications of phased arrays are well known and widely used. These principles have been transitioned in medical and nondestructive evaluation (NDE) ultrasound applications with remarkable success. Attention is directed to references [2] through [15] of attached Appendix A. The use of piezoelectric wafers for generation and reception of elastic waves has received the attention of several investigators in recent years. Attention is directed to references to references [16] through [22] of attached Appendix A.

The concept of a structural health monitoring system utilizing guided lamb waves embedded ultrasonic structural radar is proposed by Giurgiutiu et. al. in U.S. Pat. No. 6,996,480. A one dimensional straightly aligned piezoelectric wafer active sensor (PWAS) array was implemented using an embedded ultrasonic structural radar EUSR concept to construct the transmitting and receiving beams. A limitation of the 1-D linear PWAS array is its limited viewable range for 0°˜180°. Other applications of using 1-D linear ultrasonic phased arrays for damage detection can be found in references [23] through [29] and of using 2-D omnidirectional arrays in references [30] through [32], all listed in the previously noted attached Appendix A.

The present invention seeks to overcome the disadvantages of prior art construction and methods by introducing a generic beamforming formulation without using the conventional parallel ray approximation for phased array applications, introducing a generic beamforming formula for general phased array design, and using the two aforementioned principles to perform omnidirectional damage detection.

### SUMMARY OF INVENTION

The present subject matter is direct to apparatus and methodologies for performing omnidirectional (360°) damage detection in a thin-wall structure using a planar embedded piezoelectric wafer active sensors (PWAS) phased array for the transmission and reception of guided waves and a signal processing methodology based on the delay-and-sum beamforming process currently used in phased array applications. The conventional beamforming has been adapted to the specifics of traveling guided waves in thin wall structures and implemented through a signal post-processing procedure. The concept of virtual beamforming and scanning has been named as embedded ultrasonic structural radar (EUSR) in U.S. Pat. No. 6,996,480. The present invention implements the EUSR using a more generic formulation and is applied to the omnidirectional damage detection using planar PWAS phased array. The generic beamforming formulation ensures that the array can scan the area close to the array with good accuracy. The method, in accordance with the present subject matter, can be applied to thin wall structures with either plane or curved surfaces.

The omnidirectional damage detection using the planar PWAS phased array concept is shown in various experiments. In one such experiment, a small simulated-crack was detected at the 90° broadside and 270° broadside locations on a thin sheet specimen for different array orientation set-ups, respectively. The simulated crack was 19 mm (¾-in) long, 0.127 mm (0.005-in) wide. The specimen was a 1220-mm (4-ft) square panel of 1-mm (0.040-in) thick 2024-T3 Al-clad aircraft grade sheet metal stock. The simulated crack was placed at the vertical center (90° or 270° depending on the planar array orientation) and at R=305 mm from the PWAS array center. The virtual beamforming and scanning algorithm allowed the detection of the simulated crack and its position with good accuracy.

The main advantage of these omnidirectional planar PWAS phased arrays over existing ultrasonic phased array NDE/NDI/NDT technology resides in their ability to scan a 360° full range. They can interrogate any point in a plane to implement 360° scanning because the planar arrays have omnidirectional beamforming ability and can provide additional variables for controlling the beamforming pattern of the array with lower side lobes compared with the 1-D linear arrays.

The present subject matter permits scanning of large structural areas from a single location using guided plate waves (Lamb waves) that can travel at large distances inside thin-wall structures, which are transmitted and received by an array of piezoelectric-wafer active sensors (PWAS). Using the generic beamforming formulas, an array of a certain configuration can be designed and corresponding beamforming characteristics easily obtained, without requiring far field assumptions. The present subject matter permits non-uniform PWAS phased arrays with better beamforming characteristics to fit different damage detection requirements. It also incorporates advanced signal processing techniques to improve EUSR mapped image quality and offer additional processing and analyzing abilities such as de-noising, filtering, time of flight (TOF) measurement, and crack size measurement. The present subject matter can be embedded and is lightweight and inexpensive, thereby making it useful for an in situ structural monitoring system.

The major potential industrial application of the present subject matter is in the fields of structural health monitoring, damage detection, and failure prevention for critical structures with thin-wall construction. Targeted applications include military and civilian aircraft fleets, critical pressure vessels in the energy generating industry, oil tanks and pipelines, automotive, rail, etc. The organizations likely to use the method and the device that make the object of the present subject matter include federal and industrial laboratories, original equipment manufacturers, and operators of aerospace, energy generation, nuclear, oil, automotive, and related industries that are required to assure the safety of their products by structural health monitoring and nondestructive evaluation.

It is to be understood by one of ordinary skill in the art that the present discussion is a description of exemplary embodiments only, and is not intended as limiting the broader aspects of the present subject matter. It will be apparent to those of ordinary skill in the art that modifications and variations can be made in the present subject matter without departing from the scope or spirit thereof. For instance, features illustrated or described as part of one embodiment may be used in another embodiment to yield a still further embodiment. Thus, it is intended that the present subject matter covers such modifications and variations.

The present embedded ultrasonic structural radar (EUSR) concept is comprised of: (a) a piezoelectric-wafer active sensors (PWAS) array embedded onto a structure; and (b) an electronic module for signal transmission/reception, processing, and interpretation. PWAS arrays are comprised of type I elements that can be arranged in various configurations as illustrated in FIGS. 1a-1f. FIG. 1a illustrates the simplest and most widely used one-dimensional (1-D) PWAS array. The planar PWAS array consists of a total of M piezoelectric wafer active sensors (PWAS) arranged in various grids to form a planar array, such as those shown in FIGS. 1(b) thorough 1(f). The electronic module for signal transmission/reception, processing, and interpretation is comprised of: (a) a one-burst signal generator which creates a synthesized window-smoothed tone-burst signal with adjustable amplitude and repetition rate; (b) a transmission beamformer (algorithm) at angle φ₀; (c) a reception beamformer (algorithm) at angle φ₀; (d) a high-speed A/D converter and digital storage; and (e) a signal processing unit for signal enhancement, time of flight (TOF), and range estimation.

The implementation and corresponding proof-of-concept experiment of the 1-D PWAS array (FIG. 1(a)) is described in detail in U.S. Pat. No. 6,996,480. The present subject matter aims to introduce a generic PWAS phased array design formulation, improvements and illustration of the 1-D PWAS array, and implementation and illustration of planar PWAS array development. The experiments disclosed herein to illustrate the present subject matter were performed on 1-mm gauge 2024-T3 aluminum alloy aircraft-grade sheet material and used an 8-PWAS 1-D linear array or a 4×8 rectangular PWAS array to identify a through-the-thickness crack oriented parallel to the longitudinal direction of the array and centered at the vertical direction. The crack was 305 mm (12 in) away from the center of a plate. The configuration of plate and PWAS array was generally as illustrated in FIG. 2(a).

The present subject matter is directed to a system that operates to detect a damage feature in a thin wall structure. The system comprises a plurality of piezoelectric sensors embedded on the structure in a random arrangement. A generator is provided that is operative to impress a pulse having a predetermined carrier frequency upon at least one of the sensors to produce guided ultrasonic waves that travel along said thin wall structure. A signal processor processes signals received at the sensors resulting from an echo from the damage feature. The processor implements a synthetic beamforming methodology for determining an angular position of the damage feature spaced apart from the plurality of sensors along a plane of the thin wall structure. The processor then calculates a distance to the damage feature.

The present subject matter is also directed to a system that operates to detect a damage feature in a thin wall structure where the system comprises a plurality of piezoelectric sensors embedded on the structure in a random pattern. A generator impress a pulse having a predetermined carrier frequency upon the sensors so as to produce guided ultrasonic waves that travel along the thin wall structure at a predetermined azimuth. A signal processor process signals received at the sensors resulting from an echo from the damage feature where the damage feature is spaced apart from the sensors along a plane of the thin wall structure. The processor then calculates a distance to the damage feature.

The present subject matter is also directed to a system as previously described wherein the PWAS transducers are arranged in a two-dimensional pattern to maximize the detection of structural defects over a 360 degree azimuthal sweep.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1(a) illustrates a linear PWAS array according to a known configuration;

FIG. 1(b) illustrates a cross PWAS array in accordance with the present technology;

FIG. 1(c) illustrates a rectangular PWAS array in accordance with the present technology;

FIG. 1(d) illustrates a rectangular ring PWAS array in accordance with the present technology;

FIG. 1(e) illustrates a circular ring PWAS array in accordance with the present technology;

FIG. 1(f) illustrates a concentric circular array in accordance with the present technology;

FIG. 2(a) illustrates a proof-of-concept PWAS arrays construction in the form of 4-ft square plate with a 4×8 PWAS array at its center;

FIG. 2(b) illustrates details of an exemplary 8-PWAS 1-D linear PWAS array using 7-mm square PWAS, separated at a distance of d;

FIG. 2(c) illustrates details of an exemplary 4×8 PWAS array separated at a distance of d in either direction;

FIG. 3 illustrates the geometrical schematics of the m^{th} PWAS and a reflector at P(\vec{r},φ);

FIG. 4a illustrates beamforming for near field;

FIG. 4b illustrates beamforming for far field.

FIG. 5 illustrates beamforming of an exemplary 8 PWAS phased array with spacing at d=0.5λ at 120° with changing r/D value;

FIG. 6 illustrates beamforming of an exemplary 8-PWAS array at 120° with r/D=10 and changing d/λ value.

FIG. 7 illustrates beamforming of PWAS array at 120°, r/D=10 using different numbers of elements;

FIG. 8(a) illustrates the steering angle influence on beamforming with an 8 PWAS array at r/D=10;

FIG. 8(b) illustrates the steering angle influence on beamforming with a 16 PWAS array at r/D=10;

FIG. 9 illustrates the steering angle influence on 30° beamforming at different r/D using M=8;

FIG. 10(a) illustrates the beamforming of 8 PWAS binomial array with r/D=0 at 90° at different d/λ;

FIG. 10(b) illustrates beamforming of binomial compared to uniform when d/λ=0.5 at 90°;

FIG. 10(c) illustrates beamforming of binomial compared to uniform when d/λ=0.5 at 45°;

FIG. 11(a) illustrates the beamforming of an 8 PWAS Dolph-Chebyshev array with r/D=10 and d/λ=0.5 showing Dolph-Chebyshev array beamforming at 90° and 45°;

FIG. 11(b) illustrates the beamforming of an 8 PWAS Dolph-Chebyshev compared to uniform and binomial at 90° with d/λ=0.5;

FIG. 11(c) illustrates the beamforming of 8 PWAS Dolph-Chebyshev compared to uniform and binomial with d/λ=0.5 at 45°;

FIG. 12 illustrates using Hilbert transform to extract an envelope of a signal;

FIG. 13(a) illustrates the original signal (with initial bang removed) for discrete wavelet transform for denoising;

FIG. 13(b) illustrates a clean signal after DWT denoising;

FIG. 13(c) illustrate the removed noise component;

FIG. 14(a) illustrates an original signal for CWT filtering;

FIG. 14(b) illustrates a CWT filtered signal at the 343 kHz;

FIG. 15(a) illustrates a window-smoothed tone-burst as the baseline for cross-correlation of PWAS signals;

FIG. 15(b) illustrates a PWAS received signal;

FIG. 15(c) illustrates the cross-correlation result of the signals illustrated in FIGS. 15(a) and 15(b);

FIG. 16 illustrates the transmitted signal and the received signal;

FIG. 17(a) illustrates 2-D 4×8 rectangular PWAS array with type I orientation so that a crack may be detected in front of the array (90°);

FIG. 17 (b) illustrates coordinates and elementary indexing of type I orientation;

FIG. 17(c) illustrates a type II orientation so that a crack may be detected behind the array (270°);

FIG. 17(d) illustrates coordinates and elementary indexing of type II orientation;

FIG. 18(a) illustrates weighted EUSR using binomial distribution;

FIG. 18(b)) illustrates weighted EUSR using Dolph-Chebyshev distribution;

FIG. 19(a) illustrates crack detection EUSR image using eight PWAS uniform array;

FIG. 19(b) illustrates crack detection EUSR image using eight PWAS Dolph-Chebyshev array;

FIG. 19(c) illustrates crack detection EUSR image using eight PWAS binomial array;

FIG. 20 illustrates an exemplary EUSR-Opt LabVIEW GUI control panel;

FIG. 21 illustrates a process for automated crack finding and sizing;

FIG. 22 illustrates six of the nine signal primitives obtained with a 9-sensor array during a broadside detection experiment with the signals shifted vertically by a DC bias for clarity;

FIG. 23 illustrates a graphical user interface (2-D EUSR-GUI) front panel wherein the angle sweep is performed automatically to produce the structure/defect imaging picture on the right;

FIG. 24 illustrates signal enhancement obtained through the phased-array method for the broadside experiment in accordance with the present subject matter;

FIG. 25(a) illustrates a proof-of-concept omnidirectional EUSR experiment using a 4×8 rectangular PWAS array using type I orientation with a ¾-in simulated crack at R=305 mm;

FIG. 25(b) illustrates crack imaging using the omnidirectional EUSR method;

FIG. 26(a) illustrates theoretical beamforming of the 2-D 4×8 rectangular array at various directions;

FIG. 26(b) illustrates beamforming of the 2-D 4×8 rectangular array at 90°;

FIG. 27(a) illustrates an original EUSR image using 2-D 4×8 rectangular PWAS array EUSR scanning using type I orientation;

FIG. 27(b) illustrates an improved EUSR image after envelope extraction and threshold processing; and

FIG. 28 illustrates a 2-D 4×8 rectangular PWAS array EUSR scanning image using type II orientation.

Repeat use of reference characters throughout the present specification and appended drawings is intended to represent same or analogous features or elements of the invention.

### DETAILED DESCRIPTION OF THE PREFERRED EMBODIMENTS

As discussed in the Summary of the Invention section, the present subject matter is particularly concerned with apparatus and methodologies for performing omnidirectional (360°) damage detection in a thin-wall structure.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

### I. Generic Beamforming for PWAS Phased Array

Ultrasonic phased arrays steer and focus ultrasonic beams at certain directions and scan a structure by applying proper delays and weights. In conventional phased array work, the parallel rays (far field) assumption is always taken. In the present invention, exact wave propagation paths are used to construct the directional beamforming formulas for the application of PWAS phased arrays of arbitrary geometry.

To find out the generic beamforming formulas for PWAS phased arrays, assume all the PWAS in the array lie in the same plane and they behave as point-wise sources and receivers (omnidirectional active sensors). In addition, assume monochromatic excitation and reception, without considering the dispersion of guided waves, and simultaneous and uniform excitation along the PWAS elements as well. Finally, the waves are assumed propagating at a constant speed c in an isotropic material. Denoting by a vector \vec{s}ₘ, the beamforming formulas are determined at the point P(\vec{r},φ) using an M-PWAS array located at {\vec{s}ₘ} (m=0, 1, . . . M−1).

Delay-and-sum beamforming is the oldest and simplest array signal-processing algorithm, remaining a powerful approach today. See reference [33] in Appendix A for further discussion of array signal processing. The idea is: if a propagating signal is present in an array's aperture, the PWAS outputs, delayed by appropriate amounts and added together, reinforce the signal with respect to noise or waves propagating in different directions. The delays that reinforce the signal are directly related to the length of time it takes for the signal to propagate between PWAS when far field (parallel ray) is assumed. In the development, a polar coordinates system is used.

As shown in FIG. 3, the target point P(\vec{r},φ) is \vec{r}ₘ away from the m^{th} element of the array, \vec{s}ₘ. \vec{ξ} is the unit direction vector pointing from the origin to P(\vec{r},φ) and \vec{ξ}ₘ is the unit direction vector pointing from the m^{th} PWAS to P(\vec{r},φ). Also, the receiving wave at the target coming from the m^{th} PWAS is yₘ(t)=f(\vec{r}ₘ,t). The origin O of the coordinate system is defined using the phase center concept, i.e., where:

$$\frac{1}{M} \sum {{s}^{->}}_{m} = 0 \qquad ( 1 )$$

The delay-and-sum beamforming is comprised of two steps: (1) applying a delay Δₘ and a weighting factor wₘ (optional) to the output of m^{th} PWAS; (2) summing up the output signals of the total of M PWAS. This processing can be expressed as:

$$z ( t ) = {\sum }_{m = 0}^{M - 1} {w}_{m} {y}_{m} ( t - {Δ}_{m} ) \qquad ( 2 )$$

The delay {Δₘ} thus can be adjusted so as to focus the array's output beam on a particular propagating direction \vec{ξ}₀ while {wₘ} is the weighting factors for further enhancing the beams' shape and reducing side lobe levels. By using the delay-and-sum method, the wave field generated at P(\vec{r},φ) by a M-PWAS array locating at {\vec{s}ₘ}, m=0, . . . , M−1 can be found. The delay and weighting formulas for different situations can be constricted

Importantly, the beamforming algorithm varies according to whether the reflector is located near to or far from the array. Using the near field definition in the antenna theory, the near field can be defined as the circular region beyond the radius

R_{Near}≧0.62\sqrt{D³/λ} (3)

and the far field is defined as the region beyond the circular area of radius

R_{Far}≧2D²/λ (4)

Here D is the maximum aperture of the array and λ is the excitation wavelength. Below R_{Near} is the very close area where other methods such as impedance measurement should be used for damage detection.

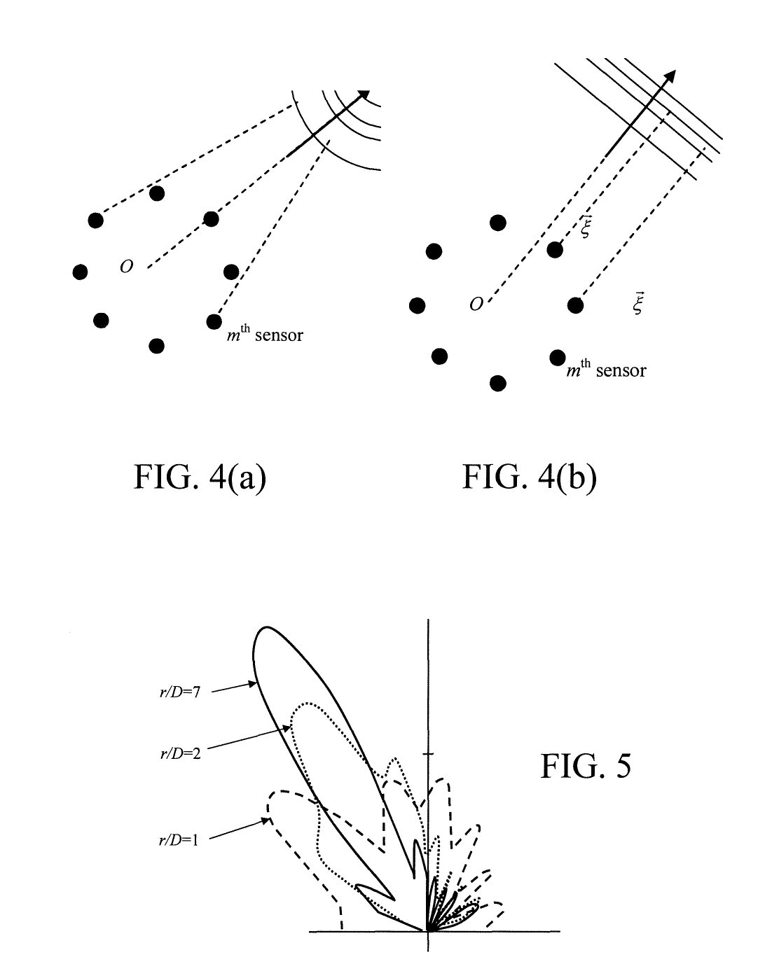

When the reflector is within near field (FIG. 4(a)), the propagating wavefront is curved (circular wavefront) with respect to the array and therefore, the wave propagating directions are dependent on the location of each sensor. For this situation, wave propagation direction varies from source to source and individual direction vectors need to assign to each sensor, i.e., for m^{th} sensor, its direction vector is \vec{ξ}ₘ. If the reflector is far away from the array (in the far field) as shown in FIG. 4(b), the propagation directions of each wave emitting from the sources are approximately parallel to each other, i.e. \vec{ξ}₀≈\vec{ξ}₁ . . . ≈\vec{ξ}_{M-1}≈\vec{ξ}, where the propagating field within the array consists of plane waves. For the far-field situation, the propagating direction is \vec{ξ} for all the plane waves, regardless of the location of the sensors.

In accordance with the present subject matter, we first deduce the generic beamforming formulas for arbitrary PWAS phased array using the full wave traveling paths and then simplify it to the far field situation using the parallel ray approximations.

The Lamb wavefront at a point located |\vec{x}| away from a PWAS source can be expressed as:

$$f ( {x}^{->} , t ) = \frac{A}{\sqrt{\vert {x}^{->} \vert}} {e}^{i ( ω t - {k}^{->} \cdot {x}^{->} )} \qquad ( 5 )$$

with wave number \vec{k}=\vec{ξ}·ω/c and ω is the angular excitation frequency of the wave. Using the exact traveling paths for each element, direction vector from m^{th} element to the target is defined as \vec{ξ}ₘ, m=0, 1, . . . M−1. With the geometry displayed in FIG. 3, if \vec{s}ₘ is the position vector of the m^{th} element, we define the following notations:

$$\begin{matrix}{ξ}^{->} = \frac{{r}^{->}}{r} , r = \vert {r}^{->} \vert , {k}^{->} = {ξ}^{->} \cdot \frac{ω}{c} & ( 6 ) \\ {{r}^{->}}_{m} = {r}^{->} - {{s}^{->}}_{m} , {r}_{m} = \vert {{r}^{->}}_{m} \vert , {{ξ}^{->}}_{m} = \frac{{{r}^{->}}_{m}}{\vert {{r}^{->}}_{m} \vert} , , {{k}^{->}}_{m} = {{ξ}^{->}}_{m} \cdot \frac{ω}{c} & ( 7 )\end{matrix}$$

Where \vec{k}ₘ is the wave number of the wave propagating in the direction of \vec{ξ}ₘ. Using these notations, the wavefront from the m^{th} PWAS element arriving at the point P(\vec{r},φ) then can be written as:

$$f ( {{r}^{->}}_{m} , t ) = \frac{A}{\sqrt{{r}_{m}}} {e}^{\{ i [ ω t - {{k}^{->}}_{m} \cdot {{r}^{->}}_{m} ] \}} \qquad ( 8 )$$

And the synthetic wavefront at P(\vec{r},φ) from total M PWAS is:

$$z ( {r}^{->} , t ) = {\sum }_{m = 0}^{M - 1} f ( {{r}^{->}}_{m} , t ) = {\sum }_{m = 0}^{M - 1} \frac{A}{\sqrt{{r}_{m}}} {e}^{\{ i [ ω t - {{k}^{->}}_{m} \cdot {{r}^{->}}_{m} ] \}} \qquad ( 9 )$$

For the generic situation, exact traveling wave paths are used for the beamforming formulation. Using the relations in Equations (6) and (7), the Equation (8) can be re-written as:

$$f ( {{r}^{->}}_{m} , t ) = f ( {r}^{->} , t - \frac{r}{c} ) \cdot \frac{1}{\sqrt{{r}_{m} / r}} {e}^{i ω ( \frac{r - {r}_{m}}{c} )} \qquad ( 10 )$$

And the synthetic signal z(\vec{r},t) in equation (9) becomes:

$$z ( {r}^{->} , t ) = f ( t - \frac{r}{c} ) \cdot {\sum }_{m = 0}^{M - 1} \frac{{w}_{m}}{\sqrt{{r}_{m} / r}} {e}^{j ω ( \frac{r - {r}_{m}}{c} )} \qquad ( 11 )$$

From Equation (11) we notice that the synthetic signal z(\vec{r},t) is fully determined by the second multiplier (summation), which depends on the locations of both the reflector and the PWAS elements. The second multiplier is then named as beamforming factor represented as:

$$BF ( r , φ , {{s}^{->}}_{m} ) = {\sum }_{m = 0}^{M - 1} \frac{{w}_{m}}{\sqrt{{r}_{m} / r}} {e}^{j ω ( \frac{r - {r}_{m}}{c} )} \qquad ( 12 )$$

It shows that the maximum of BF(r,φ,\vec{s}ₘ) will be attained when the exponential part equals to one, i.e.,

$${e}^{j ω ( \frac{r - {r}_{m}}{c} )} = 1 or \frac{r - {r}_{m}}{c} = 0.$$

According to the definition of phased array, when directional beamforming at certain direction φ₀ is desired, it means that maximum beamforming BF(r,φ,\vec{s}ₘ) should be achieved at φ₀. Therefore, by applying a direction φ₀ dependent delay Δₘ(φ₀) for the m^{th} element, making

$${e}^{j ω ( \frac{r - {r}_{m}}{c} - {Δ}_{m} ( {φ}_{0} ) )} = 1 or \frac{r - {r}_{m}}{c} - {Δ}_{m} ( {φ}_{0} ) = 0 ,$$

maximum beamforming can be achieved. This can be expressed as

$${Δ}_{m} ( {φ}_{0} ) = \frac{r - {r}_{m}}{c} \qquad ( 13 )$$

With the delays {Δₘ(φ₀)}, the beamforming factor becomes:

$$B F ( r , φ , {{s}^{->}}_{m} ) = {\sum }_{m = 0}^{M - 1} \frac{{w}_{m}}{\sqrt{{r}_{m} / r}} \qquad ( 14 )$$

By adjusting the weighting factor wₘ, the reinforcing effect of the synthetic signal can be improved. Weighting factor depends on the location of each element. To have uniform contribution of all elements, the weighting factor can be defined as:

wₘ=\sqrt{rₘ/r} (15)

With Equations (13) and (15), the beamforming at a particular direction φ₀ is:

$$B F ( r , φ , {{s}^{->}}_{m} , {φ}_{0} ) = {\sum }_{m = 0}^{M - 1} \frac{{w}_{m} ( {φ}_{0} )}{\sqrt{{r}_{m} / r}} {e}^{j ω ( \frac{r / {r}_{m}}{c} - {Δ}_{m} ( {φ}_{0} ) )} = M \qquad ( 16 )$$

Now we see that by applying proper time delays and weightings, the array's beamforming at a desired direction is achieved and reinforced.

In the previous section, the generic beamforming formula for the PWAS phased array was determined. If the parallel ray assumption is valid, i.e., the reflector is located in the far field range defined by Equation (4), the beamforming can be simplified, independent of the location of the elements. Now the propagation directions of each wave are considered to be parallel to each other, i.e., \vec{ξ}ₘ≈\vec{ξ}. Equations (6) and (7) become:

$${{k}^{->}}_{m} \approx {ξ}^{->} \cdot \frac{ω}{c} = {k}^{->} and \sqrt{{r}_{m}} \approx \sqrt{r} \qquad ( 17 )$$

Then, Equation (8) becomes:

$$f ( {{r}^{->}}_{m} , t ) \approx f ( {r}^{->} , t - \frac{r}{c} ) \cdot {e}^{\{ i \frac{ω}{c} {ξ}^{->} \cdot {{s}^{->}}_{m} \}} \qquad ( 18 )$$

Applying delaying and weighting, the beamforming factor BF(r,φ,\vec{s}ₘ,φ₀) at certain direction of M PWAS is:

$$B F ( r , φ , {{s}^{->}}_{m} , {φ}_{0} ) = {\sum }_{m = 0}^{M - 1} {w}_{m} {e}^{j ω ( \frac{r / {r}_{m}}{c} - {Δ}_{m} ( {φ}_{0} ) )} \qquad ( 19 )$$

At this direction φ₀, by setting:

$${Δ}_{m} ( {φ}_{0} ) = \frac{{ξ}^{->} \cdot {{s}^{->}}_{m}}{c} and {w}_{m} = 1 \qquad ( 20 )$$

the synthetic signal z(\vec{r},t) will be M times reinforced f(\vec{r},t).

As noted, the delay and weighting Equation (20) holds only when the far field assumption is valid. However, the Equation (13) and (15) can be used for any situation, regardless of the target position.

### II. Optimization of Linear PWAS Phased Array

Linear phased array is the simplest and one of the most practical arrays being used. Applying the generic beamforming to the existing patented 1-D PWAS array, we obtain the directional beam at certain angle φ₀ using the triangular algorithm

$$B F ( {φ}_{0} , \frac{d}{λ} , \frac{r}{d} , M ) = \frac{1}{M} {\sum }_{m = 0}^{M - 1} {w}_{m} \cdot \frac{exp \{ j 2 π \frac{d}{λ} \frac{r}{d} ( 1 - {r}_{m} - {δ}_{m}^{*} ( {φ}_{0} ) ) \}}{\sqrt{{r}_{m}}} \qquad ( 21 )$$

with δₘ*(φ₀)=1−rₘ(φ₀). Equation (21) indicates that the beam steering at certain direction φ₀ is affected by several parameters: (1) the spacing between adjacent PWAS d; (2) the number of PWAS M; (3) steering angle φ₀; and (4) weighting factors {wₘ}. Among these parameters, the effect of spacing d is always measured by the wavelength λ where λ is the wavelength of the excitation signal. Since λ=c/f, the wavelength λ will change with the frequency. Therefore, the ratio of d/λ will also change. For general beamforming, there is an extra effect caused by the ratio of r/d. So the factor (1) can be analyzed by these two factors, the ratio d/λ and the ratio r/d.

Furthermore, during the beamforming, if all weighting factors are set to be equal, i.e., all elements in the array are uniformly excited; this type of phased array is called a uniform array. Otherwise, if {wₘ} varies among the elements, the array is called a non-uniform array. The triangular beamforming factor can be used to first explore how these parameters affect the uniform PWAS phased array beamforming and then how the beamforming is affected by the weighting factors. If not mentioned, the weighting {wₘ} is set to be unit.

The ratio r/d is used to determine in triangular algorithm whether a target is located in the far or near field to the phased array. To easily quantify this value, array span D is used to quantify this variable. According to the near field definition of Equation (3), it can be deduced that:

$$\frac{r}{D} > 0.62 \sqrt{( M - 1 ) \frac{d}{λ}} Near field \frac{r}{D} > 2 ( M - 1 ) \cdot \frac{d}{λ} Far field \qquad ( 22 )$$

with D=(M−1)d. We can see, for a particular application of 8 PWAS array spacing at half wavelength (d=λ/2), the near field is the range beyond 1.16D and the far field is beyond 7D. Below 1.16D is the very close to the array area and in between is the transition from near to far. Starting from r/D ratio of 1 (r/d=M−1), to 2, 5, and 7, Figure a shows the beamforming evolution of an 8-PWAS array with d/λ=0.5 at 120°.

From the simulation results it can be seen that at very close to the array field (r/D=1), the directionality almost does not exist. Moving to far field (r/D=2), however, directivity starts forming. When the far field is approached, good directivity can be successfully obtained and no more obvious changes occur in the far field.

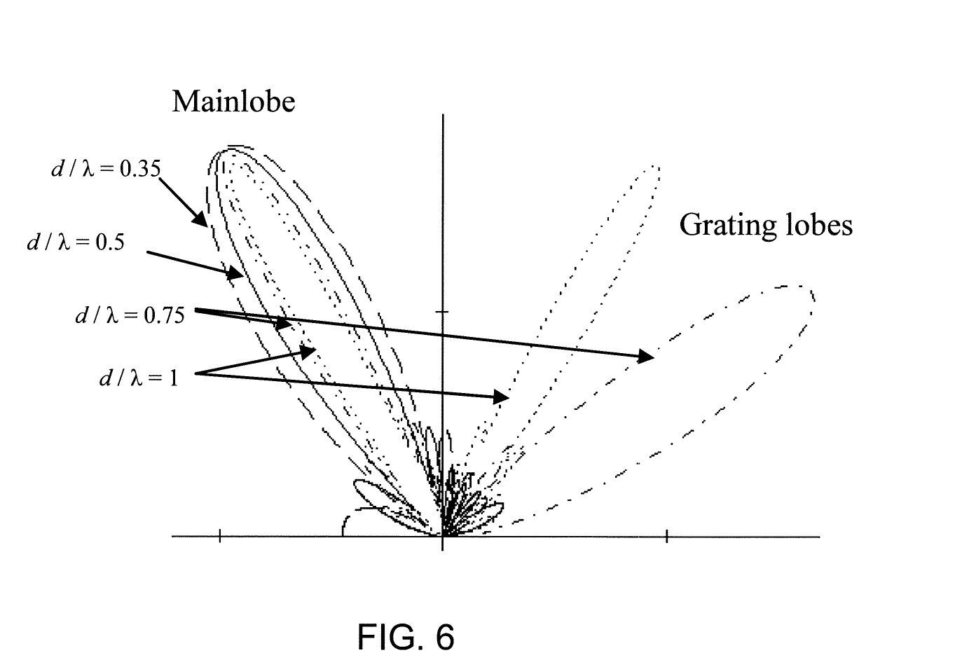

The ratio d/λ also shows the influence of spacing d on the array beamforming. Simulation results of an 8-PWAS array directed to 120° for various d/λ values are shown in Figure. FIG. 6 shows values obtained for 0.35 (dash line), 0.5 (solid line), 0.75 (dash dot line), and 1 (dot line). It can be seen that the main lobe width becomes smaller when d/λ increases with less side lobe effect. For larger d/λ values, better directivity can be achieved. However, for the value of d/λ=0.75 and d/λ=1, besides the main lobe at desired angle (120°), there is another beam which has exactly the same amplitude as the main lobe while it shows up in an undesired direction. Such a lobe is called a grating lobe. It is not desired and can mislead inspection results. Theoretically, the spatial sampling theorem states that the spacing d between elements should be smaller or equal to the half of wavelength (d/λ≦0.5) in order to avoid spatial aliasing; otherwise grating lobes will show up.

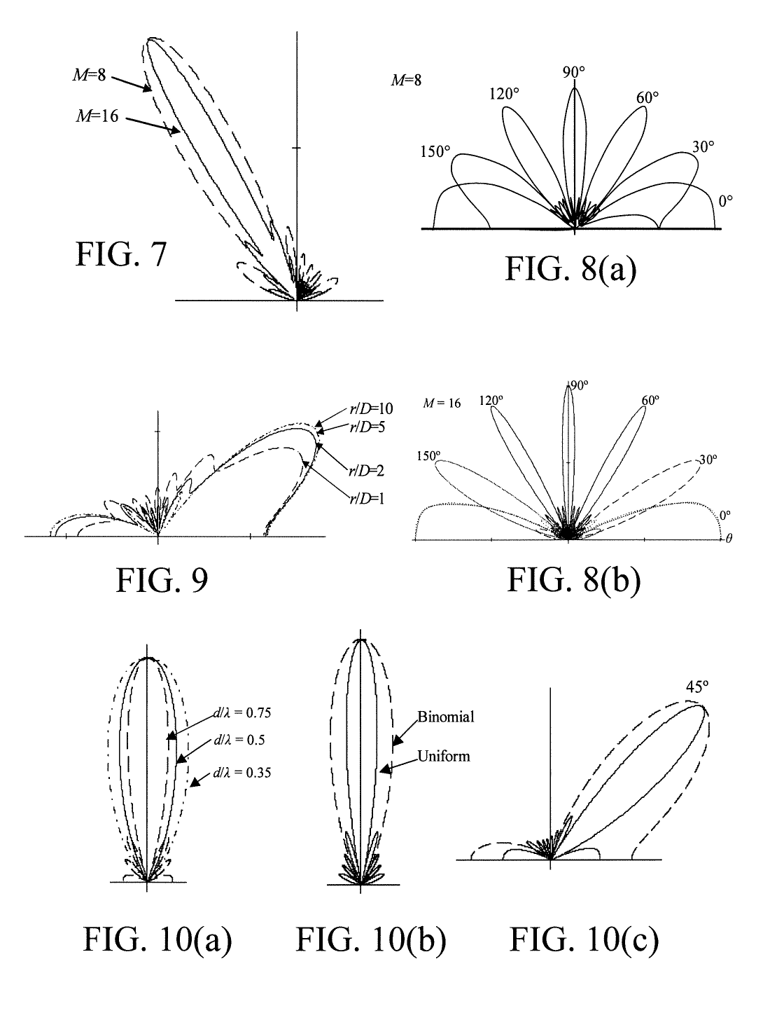

We have evaluated the influence of the spacing d on the array beamforming and found out that larger d will result in better directivity yet with larger side lobes. However, increasing d is limited by the sampling theorem to avoid grating lobes. The number of elements in the array is another factor that affects the directivity. FIG. 7 shows the beamforming at different M. FIGS. 8(a) and 8(b) show the results of the 120° beamforming using M=8 (FIG. 8(a)) and M=16 (FIG. 8(b)) both at D/r=10 (far field) and d/λ=0.5. The diagrams show that with 16 PWAS, there is a finer (narrower) main lobe and slightly higher side lobes, compared to the beamforming with 8 PWAS. This illustrates the fact that larger M will bring better directionality yet larger side lobe effect. Note that increasing M is limited by the wiring issue and spacing limitation.

Steering angle φ₀ (beamforming direction) can also affect the beamforming. The directional beamforming at 0°, 30°, 60°, 90°, 120°, 150° using 8 PWAS and 16 PWAS are shown in FIGS. 8(a) and 8(b) respectively. It can be seen how the beamforming starts from not existing (0°), then the back lobe shrinks and the directional main lobe increases (30° and 60°). When it gets closer to 180° (150°), the back lobe increases and main lobe shrinks until completely losing the directivity at 180°. This means that for a linear PWAS array, it does not have a complete 180° view but a slightly smaller one. Comparing the two results, it also can be found that an array with larger M has a larger view area. For an 8-PWAS array, when moving the beam from 0° to 30°, the directionality gets better with side lobes being suppressed. Compared to beamforming with 8 PWAS, the beamforming with 16 PWAS shows better directionality at lower angles such as 30°.

Whether r/D ratio affect the beamforming at critical angle such as 30° for an 8 PWAS array is also examined. From the result shown in Figure, we can see that the value of r/D has little affect on the beamforming especially for far field (notice that beamforming for r/D=10 and r/D=5 are barely distinguishable).

The non-uniformly excited linear PWAS array is considered. Two widely used excitation distribution, binomial and Dolph-Chebyshev distribution, are used to determine the relative excitation amplitudes along the array.

The excitation coefficients or weighting factors {wₘ} for a binomial array can be derived by writing the function (1+x)^{M+1} into a series using the binomial expansion:

$${( 1 + x )}^{M - 1} = 1 + ( M - 1 ) x + \frac{( M - 1 ) ( M - 2 )}{2 !} {x}^{2} + \frac{( M - 1 ) ( M - 2 ) ( M - 3 )}{3 !} {x}^{3} + … \qquad ( 23 )$$

Therefore, we can get the positive coefficients of the series for different values of M and find the relative amplitude series {wₘ} for the array using such an expansion. Since the excitation is determined from a binomial series expansion, it is called as a binomial array.

For an 8 PWAS array, the coefficients are {1, 7, 21, 35, 35, 21, 7, 1}. Simulation results of such a binomial array at different d/λ values are shown in FIG. 10(a) results demonstrate that with increasing d/λ, the main lobe becomes thinner resulting in better directivity, especially when d/λ=0.5, the binomial beamforming has no side lobes at all (the solid beam), which is the most significant characteristic of binomial arrays. This can be compared to the beamforming using the uniform array shown in FIG. 10(b). Though having a wider beam compared to the equivalent uniform array, the binomial array has a better side lobe level (no side lobe at all). However, if we look at the directional beamforming at 45° shown in FIG. 10(c), we see that the binomial array has worse beamforming and side lobe appears. It means the binomial array has a smaller view area than the uniform array and at a lower angle, it still has side lobe.

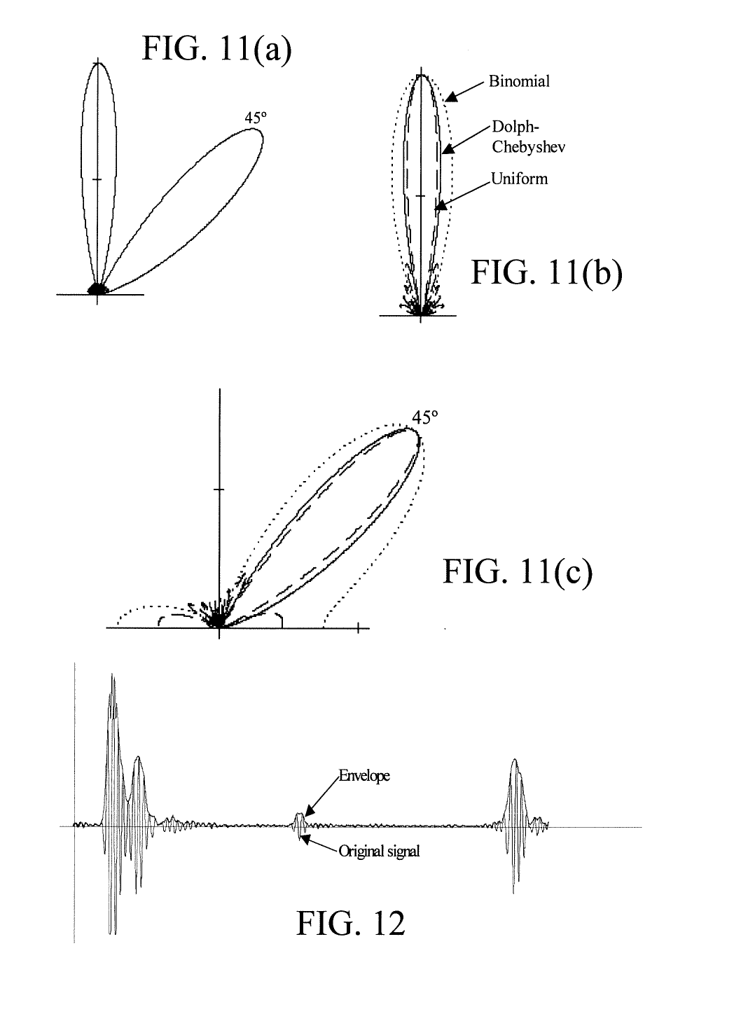

As shown above, though a binomial array has less side lobe level at certain directions compared to the uniform array, it has worse directivity and smaller view area. Also, if looking into the excitation series {1, 7, 21, 35, 35, 21, 7, 1}, we see the amplitudes change significantly from one to another (e.g., the coefficients for 1^{st} element on the left is only 1/126 of the 5^{th}). Another non-uniform array is the Dolph-Chebyshev array using the Chebyshev distribution. It is originally introduced to be a compromise between uniform and binomial arrays (considering the side lobe level and directivity) with relatively smooth amplitude distribution along the array. By choosing the side lobe level, i.e., the ratio of main lobe to the first side lobe, the Dolph-Chebyshev array coefficients can be determined. For a desired side lobe level 20, the coefficients {wₘ} can be found to be {0.357, 0.485, 0.706, 0.89, 1, 1, 0.89, 0.706, 0.485, 0.357}. Notice both binomial and Dolph-Chebyshev coefficients are symmetric about the origin. Beamforming of the Dolph-Chebyshev arrays at 90° and 45° with d/λ=0.5 is shown in FIG. 11(a). With the design of side lobe level at 20, the side lobe is mostly suppressed. FIGS. 11(b) and 11(c) are comparisons of the three uniform, binomial and Dolph-Chebyshev arrays at 90° and 45° respectively. The dot beam is for a binomial array, solid beam is for a Dolph-Chebyshev array, and the dash beam is for a uniform array. It clearly shows that when considering the side lobe level, the binomial array has zero side lobes, followed by the Chebyshev array and the uniform array. However, the uniform array has the best directivity, followed by the Chebyshev array and the binomial array. The results of these studies show that the Dolph-Chebyshev array can be used as a balance of low side lobe level and good directivity.

### III. Advanced Signal Processing for Improved EUSR Performance

The envelope of a family of curves or surfaces is a curve or surface that is tangent to every member of the family. The envelope represents the amplitude of a periodic signal. The Hilbert transform can be used to construct an analytical signal that has the envelope of the original signal. The Hilbert transform is defined by Poularikas in reference [37] in the attached Appendix A.

$$H ( x ( t ) ) = - \frac{1}{π} {\int }_{- ∞}^{+ ∞} \frac{x ( τ )}{t - τ} d t \qquad ( 24 )$$

To build an analytical signal \tilde{x}(t), we use the original signal x(t) for constructing the real part while using the result of the Hilbert transform H(x(t)) as the imaginary part, i.e.:

\tilde{x}(t)=x(t)+jH(x(t)) (25)

The analytical signal has the same envelope as the original signal:

|\tilde{x}(t)|=|x(t)| (26)

Hence we can find out the envelope of the original signal x(t) by taking the magnitude of the analytical signal \tilde{x}(t). FIG. 12 shows the resulting envelope using Hilbert transform. The original signal shows many local maxima, which introduces a difficulty in using a peak detection method to precisely indicate the presence of the crack. After extracting the envelope, there is only one peak to consider, and peak detection method can be easily applied.

As shown in FIG. 12, some small noise still shows up in the extracted envelope, resulting in the ripples in the mapped image as the background noise. To remove it, a thresholding process is included after the Hilbert transform. During the thresholding process, any magnitude below the threshold value will be forced to zero and those above will simply remain.

As options, denoising using discrete wavelet decomposition and single frequency filtering based on continuous wavelet transform modules are developed for: 1) removing background or measurement noise; 2) extracting the frequency component at the excitation frequency to avoid dispersion interference; and 3) obtaining precise mapping of EUSR images. Detailed information about these can be found in reference [38] in the attached Appendix A.

Based on multiresolution analysis (MRA), the Discrete Wavelet Transform (DWT) provides a tool for decomposing signals into elementary mutually orthogonal sets of building blocks, which are called wavelets. The DWT is defined as

$${c}_{m , n} = {\int }_{- ∞}^{+ ∞} x ( t ) {Ψ}_{m , n} ( t ) d t \qquad ( 27 )$$

where Ψ_{m,n}(t) are orthonormal wavelets obtained by shifting and dilating a mother wavelet ψ(t).

Ψ_{m,n}(t)=2^{-m/2}Ψ(2^{-m}t−n) (28)

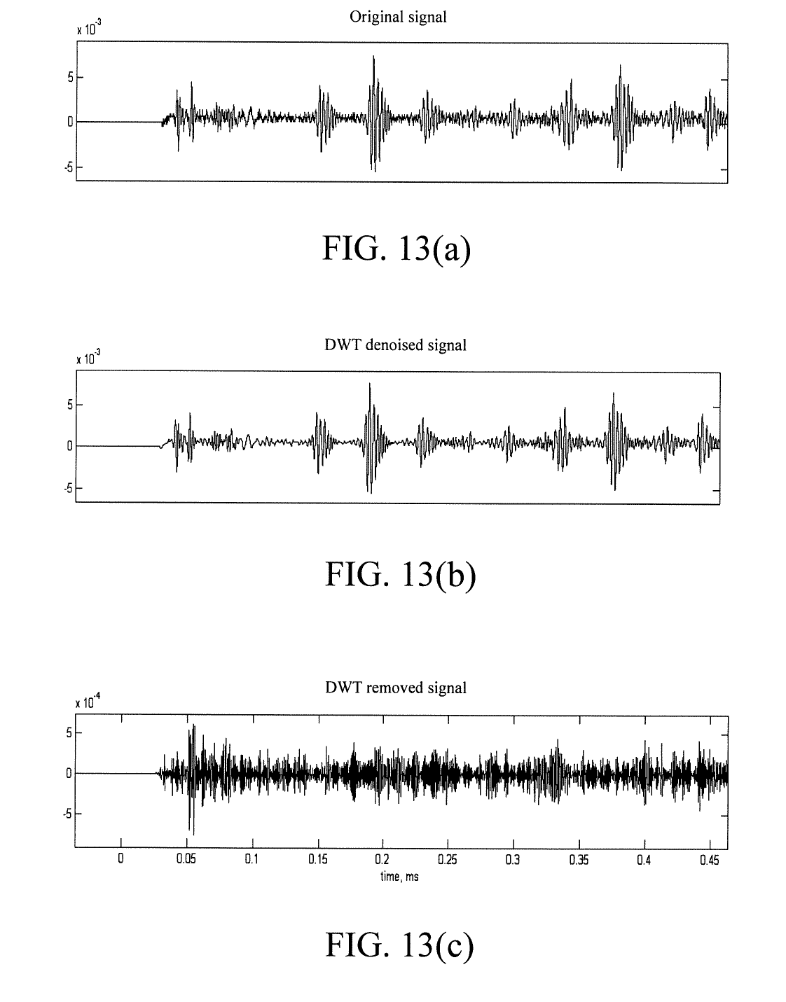

The coefficients c_{m,n} are usually thought of as a filter and applied to the raw data, working as a highpass filter and a lowpass filter to bring out the data's approximation and detail information, respectively. Such a process will continue until a few data remain which are within the user-defined allowable error range. Meanwhile, since half the frequencies of the original signal are removed after the filtering process, half the signal samples can be discarded with the Nyquist rule by a downsampling process of a factor of 2. The decomposition will be repeated to further increase the frequency resolution until a few data remain which are within the user-defined allowable error range. This procedure is known as the filter bank. An example of DWT denoising is shown in FIG. 13.

The Continuous Wavelet Transform (CWT) of signal x(t) by using mother wavelet ψ(t) is:

$$C W T ( a , τ ) = \frac{1}{\sqrt{\vert a \vert}} \int x ( t ) {ψ}^{*} ( \frac{t - τ}{a} ) d t \qquad ( 29 )$$

where ψ(t) is the mother wavelet, a is the scaling (or dilation), τ is the translation (or time shift) of the wavelet with respect to the signal, and the factor 1/\sqrt{|a|} is introduced for energy normalization at different scales. The resulting time-frequency representation of the magnitude squared, |CWT(a,τ)|², is named a scalogram, represented as:

$${\vert W T ( a , τ ) \vert}^{2} = \frac{1}{{\vert a \vert}^{2}} {\vert \int x ( t ) {ψ}^{*} ( \frac{t - τ}{a} ) d t \vert}^{2} \qquad ( 30 )$$

The relation between the scale a and commonly used parameter frequency f is:

$$f = \frac{center frequency of the wavelet}{scale \cdot sampling interval} \qquad ( 31 )$$

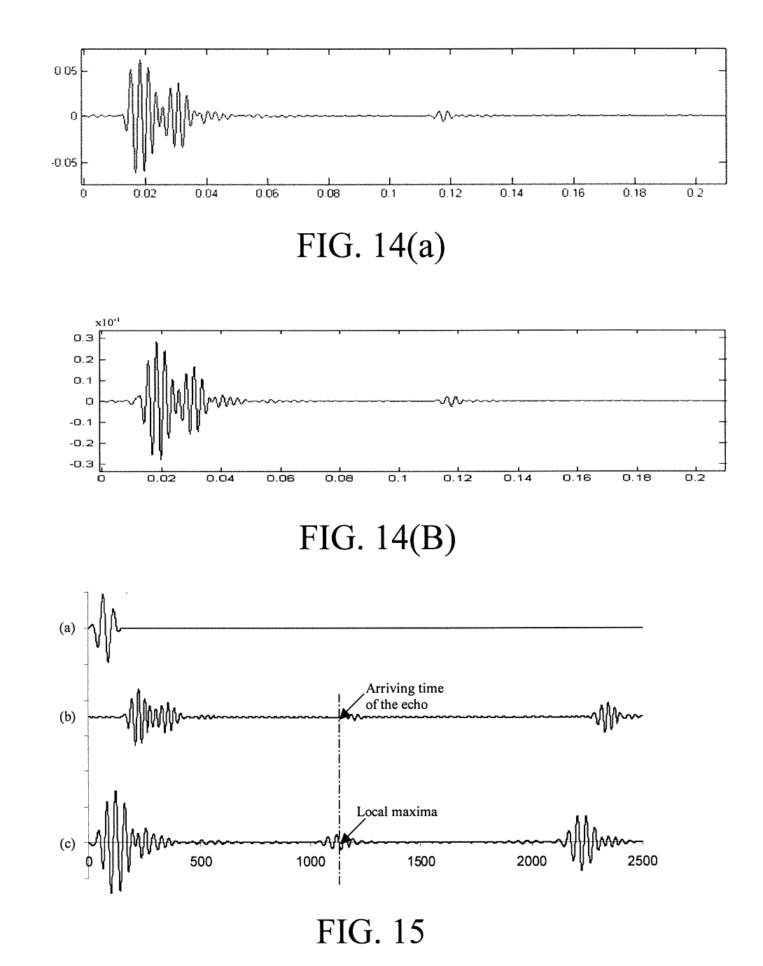

For a particular frequency of interest, the coefficients at corresponding scale (frequency) can be retrieved, such action termed CWT filtering. FIG. 14 shows the original signal received during EUSR experiment and the CWT filtered frequency component at 343 kHz.

Cross correlation is used to detect similarities in two signals and used for TOF detection. The cross correlation R_{xy}(m) of two discrete signals x(n) and y(m) is defined by:

$${R}_{xy} ( m ) = \frac{1}{N} {\sum }_{n = 0}^{N - 1} x ( n ) y ( n - m ) \qquad ( 32 )$$

The process can be explained as: the input signal x(n) slides along the time axis of the correlated signal y(m) with a small step while the similarity of the overlapped part of two signals is compared. If the two signals are completely not similar (unrelated), the corresponding coefficients are 0, while if they are completely identical, the coefficients are 1. For real signals, the cross correlation method can reduce the annoyance of noise since the noise is not related to the signals and not auto-related either. An example is demonstrated in FIG. 15 where a received PWAS signal (FIG. 15(a)) is correlated with the ideal 3-count tone burst excitation (FIG. 15(b)). A cross correlation coefficient curve is shown in FIG. 15(c). Note that it has several local maxima, corresponding to the arrival time of each wave packet. By applying a peak detection method, we can pick out those peaks and therefore, determine the arrival time of each wave packet.

The principle of operation of the general embedded ultrasonic structural radar (EUSR) using generic beamforming formulas is derived from two general principles: 1) the principle of guided Lamb wave generation with piezoelectric wafer active sensors (PWAS); and 2) the principles of conventional ultrasonic phased array.

The guided Lamb waves generated by PWAS stay confined inside the walls of a thin-wall structure, and hence can travel over large distances. In addition, the guided waves can also travel inside curved walls, which makes them ideal for applications in the ultrasonic inspection of aircraft, missiles, pressure vessel, oil tanks, pipelines, etc. Lamb waves can exist in a number of dispersive modes. However, through smoothed tone-burst excitation and frequency tuning, it is possible to confine the excitation to a particular Lamb wave mode, of carrier frequency f_{c}, wave speed c, and wave length λ=c/f_{c}. Hence, the smoothed tone-burst signal generated by one PWAS is of the form:

s_{T}(t)=s₀(t)cos 2πf_{c}t, 0≦t≦tₚ

where s₀(t) is a short-duration smoothing window that is applied to the carrier signal of frequency f_{c} between 0 and tₚ.

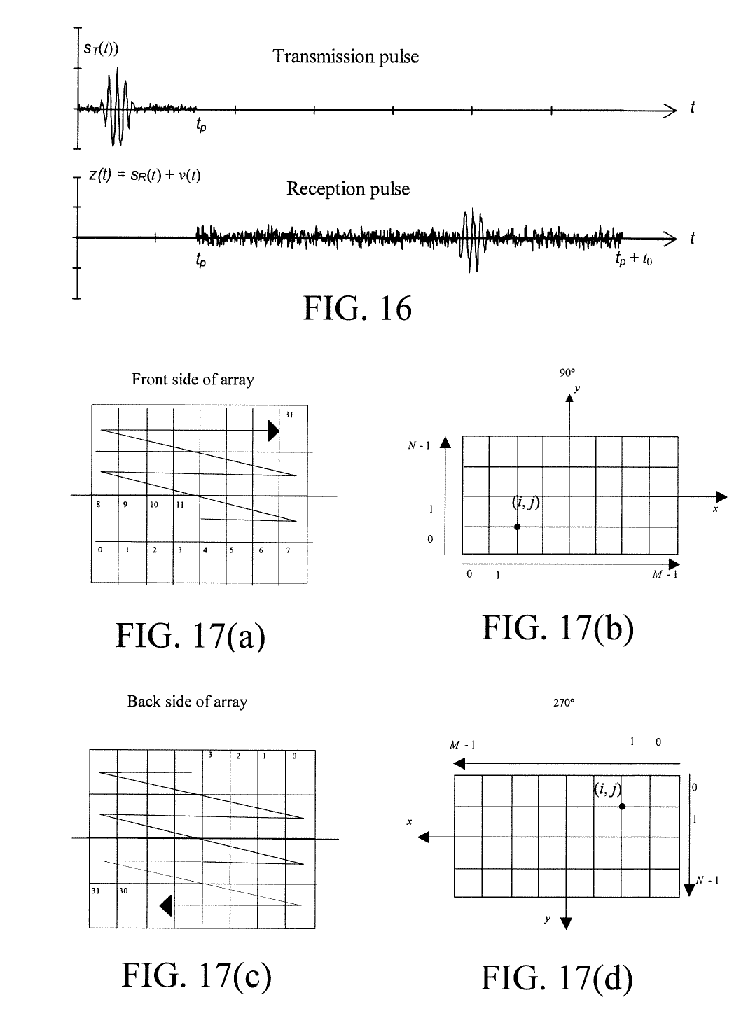

The principle of a PWAS array of M elements is applied to the PWAS-generated guided waves. If all the PWAS in the array are fired simultaneously, the signal from the m^{th} PWAS will arrive at the target point P quicker by Δₘ(φ)=[r(φ)−rₘ]/c with respect to the traveling time needed from the origin O to the target (path |OP|), where rₘ=|\vec{r}(φ)−\vec{s}ₘ|. However, if the PWAS are not fired simultaneously, but with some individual delays, δₘ, m=0, 1, . . . , M−1, the total signal received at point P will be:

$${s}_{p} ( t ) = {\sum }_{m = 0}^{M - 1} \frac{1}{\sqrt{{r}_{m}}} {s}_{T} ( t - \frac{r}{c} + {Δ}_{m} ( φ ) - {δ}_{m} ) \qquad ( 33 )$$

wherein 1/\sqrt{rₘ} represents the decrease in the wave amplitude due to the omnidirectional 2-D radiation of the propagating guided waves, and r/c is the delay caused by the reference distance |OP| (here wave-energy conservation, i.e., no dissipation, is assumed.). FIG. 16 is an example of the transmitted signal and received signal pair captured in the present experiment.

Based on phased array theory, the transmission and reception of the EUSR algorithm are presented respectively, resulting in the pulse-echo inspection.

If we can make δₘ=Δₘ(φ), then Equation (33) becomes

$${s}_{p} ( t ) = {s}_{T} ( t - \frac{r}{c} ) {\sum }_{m = 0}^{M - 1} \frac{1}{\sqrt{{r}_{m}}} \qquad ( 34 )$$

That is, there is an

$${\sum }_{m = 0}^{M - 1} \frac{1}{\sqrt{{r}_{m}}}$$

times increase in the signal strength. This leads directly to the beamforming principle developed previously. Then beamforming takes place when angles φ=φ₀ and φ=−φ₀. Thus, the forming of a beam at angles φ₀ and −φ₀, is achieved through delays in the firing of the sensors in the array.

If the point P is an omnidirectional source at azimuth φ₀, then the signals received at the m^{th} sensor will arrive quicker by Δₘ(φ₀)=[r(φ₀)−rₘ]/c. Hence, we can synchronize the signals received at all the sensors by delaying them by δₘ(φ₀)=Δₘ(φ₀).

Assume that a target exists at azimuth φ₀ and distance R. The transmitter beamformer is sweeping the range in increasing angles φ and receives an echo when φ=φ₀. The echo will be received on all sensors, but the signals will not be synchronized. To synchronize the sensors signals, the delays defined by Equation 13 using near field algorithm or Equation 20 using far field algorithm need to be applied. Then the synthetic signal arriving at the target is:

$${s}_{p} ( t ) = {s}_{T} ( t - \frac{R}{c} ) {\sum }_{m = 0}^{M - 1} \frac{1}{\sqrt{{r}_{m}}} \qquad ( 35 )$$

At the target, the signal is backscattered with a backscatter coefficient, A. Hence, the signal received at each sensor will be:

$$( A {\sum }_{m = 0}^{M - 1} \frac{1}{\sqrt{{r}_{m}}} ) \cdot {s}_{T} ( t - \frac{R}{c} + {Δ}_{m} ( {φ}_{0} ) ) \qquad ( 36 )$$

The receiver beamformer assembles the signals from all the sensors with the appropriate delays.

$${s}_{R} ( t ) = ( A {\sum }_{m = 0}^{M - 1} \frac{1}{\sqrt{{r}_{m}}} ) {\sum }_{m = 0}^{M - 1} \frac{1}{\sqrt{{r}_{m}}} \cdot {s}_{T} ( t - \frac{R}{c} + {Δ}_{m} ( {φ}_{0} ) - {δ}_{m} ) \qquad ( 37 )$$

Constructive interference between the received signals is achieved when δₘ=Δₘ(φ₀). Thus, the assembled receive signal will be again boosted

$${\sum }_{m = 0}^{M - 1} \frac{1}{\sqrt{{r}_{m}}}$$

times, with respect to the reference signal from origin to the target:

$${s}_{R} ( t ) = {A ( {\sum }_{m = 0}^{M - 1} \frac{1}{\sqrt{{r}_{m}}} )}^{2} {s}_{T} ( t - \frac{R}{c} ) \qquad ( 38 )$$

In general, a target crack is unknown, i.e. the target location is unknown. Since we use the polar coordinates in the radar system, the location of an unknown target is defined by the angle φ₀. The coarse estimation of φ₀ is implemented by using the φ₀ sweeping method. EUSR will scan through 0° to 180° by incrementing φ₀ by 1° each time, until the maximum received energy is obtained. max E_{R}(φ₀) is the maximum received energy by the definition:

$${E}_{R} ( {φ}_{0} ) = {\int }_{{t}_{p}}^{{t}_{p} + {t}_{a}} {\vert {s}_{R} ( t , {φ}_{0} ) \vert}^{2} \qquad ( 39 )$$

The time delay between the receive signal s_{R}(t) and the transmit signal s_{T}(t) is:

$$τ = \frac{2 R}{c} \qquad ( 1 )$$

Measurement of the time delay τ observed in s_{R}(t) allows one to calculate the target range, R=cτ/2.

### III. Practical Implementation of Omnidirectional EUSR

For a planar array, different numbering will result in different array orientations, i.e., which side is the front side of the array. For the 2-D rectangular configuration, the rule of indexing is to start from left to right and then from the back to front. By this means, however, there could be two ways to index the elements in such arrays. As demonstrated in FIGS. 17(a)-(d), a broadside crack can be considered located at 90° or 270° if a different indexing method is employed. For the indexing used in FIGS. 17(a) and 17(b), the result is the type I orientation of the 2-D rectangular array, with a broadside crack in front at 90°. For the indexing used in FIGS. 17(c) and 17(d), the result is the type II orientation, with a broadside crack in the back at 270°. The two different indexing methods are used to demonstrate that the rectangular PWAS array has the omnidirectional crack detection ability, i.e., is able to identify correct crack locations under different orientations.

For convenience, a Cartesian coordinates system can be employed for a rectangular PWAS array. Once the indexing mode is chosen, the coordinates system is determined as well and the coordinates of the PWAS element can be known as (j,i). Using the following equation, the corresponding index n of an element located at (i,j) in an Mₓ×N_{y} rectangular array (M=Mₓ·N_{y}) can be determined by:

n=Mₓ·j+i (41)

Signal generation and collection proceeds in a round-robin pattern as follows: one active sensor at a time is activated as transmitter. The reflected signals are received at all the sensors where the activated sensor acts in pulse-echo mode, i.e. as both transmitter and receiver, and the other sensors act as passive sensors. All the PWAS elements in the array take turns to serve as the transmitter. Thus an M×M matrix of signal primitives is generated (as shown in Table 1).

TABLE 1
M x M matrix of signal primitives generated in a round-robin
phase-array activation of the active-sensor array

| | | Firing pattern | | | | | |
|---|---|---|---|---|---|---|---|
| | | (symbols designated the transmitters | | | | | Synthetic |
| | | that are activated) | | | | | beamforming |
| | | T₀ | T₁ | T₂ | | T_{M-1} | response |
| Receivers | R₀ | p_{0,0}(t) | p_{0,1}(t) | p_{0,2}(t) | . . . | p_{0,M}(t) | w₀(t) |
| | R₁ | p_{1,0}(t) | p_{1,1}(t) | p_{1,2}(t) | . . . | p_{1,M}(t) | w₁(t) |
| | R₂ | p_{2,0}(t) | p_{2,1}(t) | p_{2,2}(t) | . . . | P_{2,M}(t) | w₂(t) |
| | . . . | . . . | . . . | . . . | . . . | . . . | . . . |
| | R_{M-1} | p_{M-1,0}(t) | p_{M-1,1}(t) | p_{M-1,2}(t) | . . . | p_{M-1, M-1}(t) | W_{M-1}(t) |

The signal primitives are assembled into synthetic beam-responses using a synthetic beamformer algorithm:

$${w}_{i} ( t ) = {\sum }_{j = 0}^{M - 1} {c}_{j} {p}_{ij} ( t - {δ}_{j} ) , j = 0 , 1 , … , M - 1 \qquad ( 42 )$$

where δⱼ is the individual delay calculated by either the triangular or parallel algorithms and cⱼ is the weighting factor. The selection of the delays, δⱼ, is in such a way as to steer the interrogation beam at a certain angle, φ₀. The synthetic-beam sensor responses, wᵢ(t), synthesized for a transmitter beam with angle φ₀ are assembled by the receiver beamformer into the total received signal, s_{R}(t), using the same delay as for the transmitter beamformer, i.e.,

$${s}_{R} ( t ) = {\sum }_{i = 0}^{M - 1} {c}_{i} {w}_{i} ( t - {δ}_{i} ) = {\sum }_{i = 0}^{M - 1} {c}_{i} \cdot ( {\sum }_{j = 0}^{M - 1} {c}_{j} {p}_{ij} ( t - {δ}_{i} - {δ}_{j} ) ) \qquad ( 43 )$$

This method presumes that the target angle φ₀ is known a priori. In general applications, however, the target angle is not known and needs to be determined. Hence, we write the received signal as a function of the parameter φ₀, i.e.,

$${s}_{R} ( t ; {φ}_{0} ) = {\sum }_{i = 0}^{M - 1} {c}_{i} \cdot ( {\sum }_{j = 1}^{M - 1} {c}_{j} {p}_{ij} ( t - {δ}_{i} ( {φ}_{0} ) - {δ}_{j} ( {φ}_{0} ) ) ) \qquad ( 44 )$$

In a practical implementation of the method, we have used a spline interpolation approach to implement the time shifts with accuracy at times that fall in between the fixed values of the sampled time.

A coarse estimate of the target direction is obtained by using an azimuth sweep technique, in which the beam angle, φ₀, is modified until the maximum received energy is obtained, i.e.,

$$max {E}_{R} ( {φ}_{0} ) , \\ {E}_{R} ( {φ}_{0} ) = {\int }_{{t}_{p}}^{{t}_{p} + {t}_{0}} {\vert {s}_{R} ( t , {φ}_{0} ) \vert}^{2} d t \qquad ( 45 )$$

After a coarse estimate of the target direction, φ₀, is found, the actual round-trip time of flight, τ_{TOF}, is calculated using an optimal estimator, e.g., the cross-correlation between the received and the transmitted signal:

$$y ( τ ) = {\int }_{{t}_{p}}^{{t}_{p} + {t}_{0}} {s}_{R} ( t ) {s}_{T} ( t - τ ) d t \qquad ( 46 )$$

Then, the estimated τ_{TOF}=2R/c is attained at the value of τ where y(τ) is maximum. Hence, the estimated target distance is:

Rₑₓₚ=cτ_{TOF}/2 (47)

This algorithm works for any targets beyond the “very close to the array” field, with no requirement for the parallel ray approximation to be valid.

For targets in the far field, a simpler self-focusing algorithm, that uses the parallel ray approximations, is used. This algorithm is similar to the conventional phased array methodologies. The self-focusing far field parallel algorithm modifies the delay times for each synthetic-beam response by finding the delays using the formula in Equation (20). This algorithm only requires the knowledge of the location of the array elements. For very close range targets, SAFT techniques or other methods are utilized.

### IV. EUSR Algorithm Variants

The implementation of 1-D uniform (wₘ=1) linear PWAS array has been detailed in U.S. Pat. No. 6,996,480 by Giurgiutiu et. al.

EUSR-Opt is the optimized 1-D EUSR with multiple advanced signal processing functions including: 1) DWT denoising; 2) CWT filtering; 3) TOF measurement; 4) manual crack size measurement; and 5) automated crack finding and sizing.

EUSR-Bi is the non-uniform 1-D PWAS array using the binomial distribution to define the weighting factors {wₘ}.

EUSR-Cheby is the non-uniform 1-D PWAS array using the Dolph-Cheybshev distribution to define the weighting factors {wₘ}.

Two versions of omnidirectional EUSR are disclosed herein: (a) EUSR-T; and (b) EUSR-P.

EUSR-T is the complete omnidirectional EUSR algorithm, which uses the triangular algorithm based on the exact wave propagation paths.

EUSR-P is a simplified version of the omnidirectional EUSR algorithm that is simpler and faster, but uses the far field assumption so that parallel ray approximation is valid.

An automatic switching unit is used to turn on one sensor as transmitter and to collect the individual signal primitives from all the elements, for all firing patterns. The collected signal primitives are stored in the memory of a computer and processed in a batch, after the data collection phase has finished. The principle of operation of the PWAS phased array EUSR relies on the assumption of linear superposition and steady structural behavior during data collection and the signal post-processing to construct virtual beam steering. Using the appropriate delaying algorithm, the data components corresponding to each sensor and firing pattern are assembled into a total response signal using a synthetic-aperture beamforming/focusing algorithm.

### V. Experimental Illustration of Invention

The studies disclosed and described herein are intended to illustrate the present invention and are not intended to limit the scope of the invention.

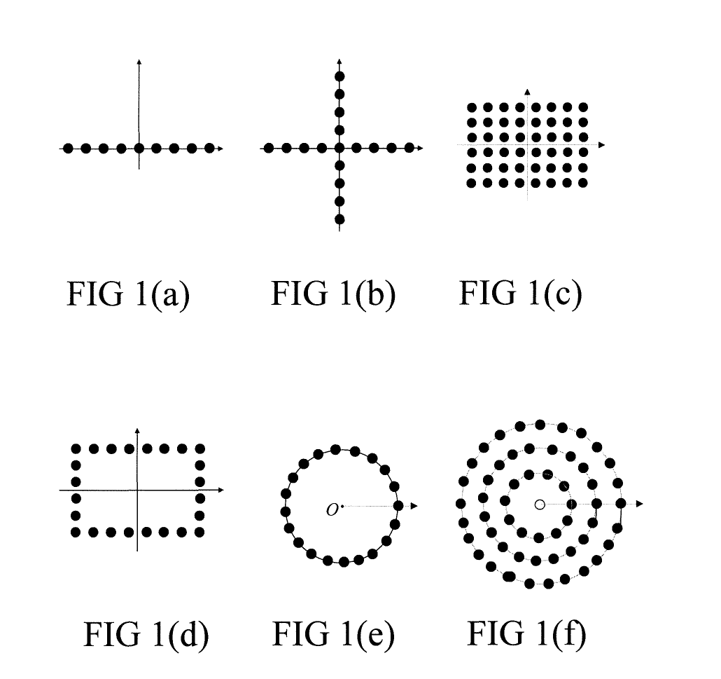

The omnidirectional planar PWAS phased array EUSR concept is illustrated in experiments using a 4×8 rectangular array (FIG. 1). In these experiments, a small simulated-crack was detected at broadside. Different array orientations will give different identifications of crack positions such that the omnidirectionality of the planar PWAS array is verified. The simulated crack was 19 mm (¾-in) long, 0.127 mm (0.005-in) wide. The specimen was 1220-mm (4-ft) square panel of 1-mm (0.040-in) thick 2024-T3 Al-clad aircraft grade sheet metal stock. The simulated crack was placed at broadside at R=305 mm from the 4×8 PWAS array center. The signal post-processing omnidirectional EUSR algorithm allowed the detection of the simulated crack at different positions under different array orientations with good accuracy.

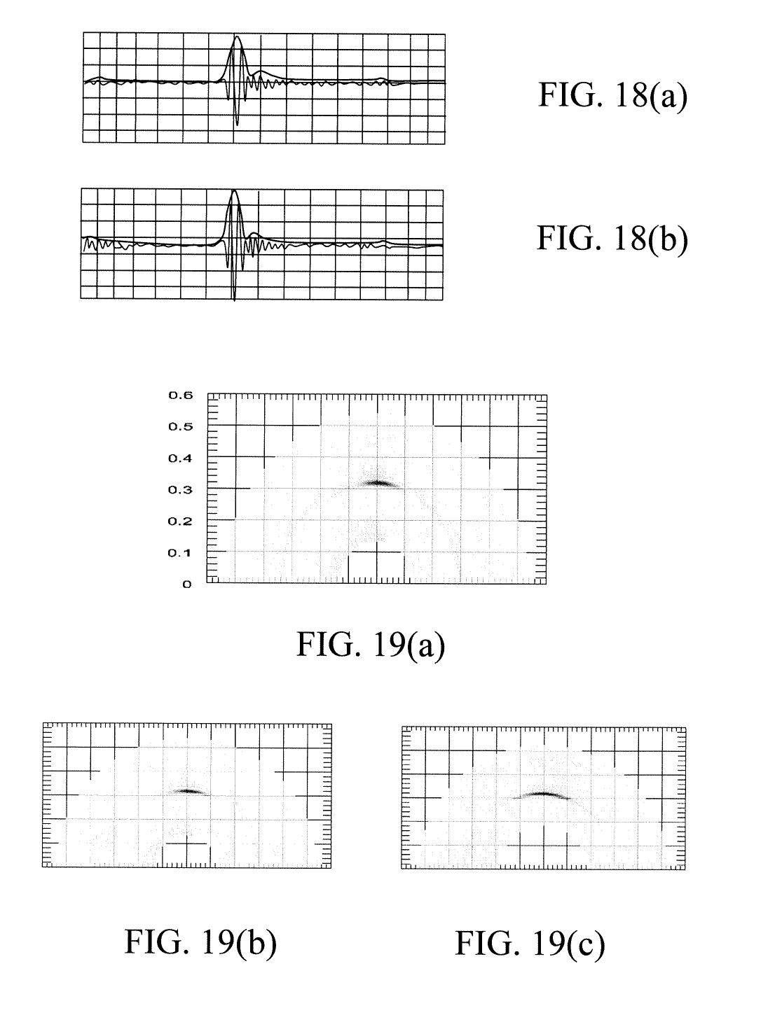

The previous description of non-uniform PWAS phased arrays shows that the Dolph-Chebyshev array is expected to have much smaller side lobe level compared to the equivalent uniform array, though having almost the same main lobe width. For a binomial array, it is expected to have much smaller side lobe level as well but with larger main lobe width compared to the uniform array. With the data used for the existing 1-D EUSR uniform array, we processed it with the weighted EUSR algorithms. Weighted EUSR using binomial distribution and Dolph-Chebyshev distribution are shown in FIGS. 18(a) and 18(b), respectively.

FIG. 19(a) is the original EUSR image of the uniform array. We notice there is a phantom shadow in the circle where crack shows up. Recalling the beamforming simulation result, we know it is caused by the side lobe effect. Since both Dolph-Chebyshev and binomial arrays theoretically have much smaller side lobe than the uniform array, the corresponding weighted EUSR scanning should give images with the phantom shadow removed or reduced.

The scanning images of the Dolph-Chebyshev array and binomial array are shown in FIG. 19(b) and FIG. 19(c), respectively. The most significant difference to notice is that the side lobe phantom has been sufficiently suppressed in both images as expected, though the crack image of the binomial array is much wider. The wider crack image further verifies that the binomial array has the largest main lobe width among the three.

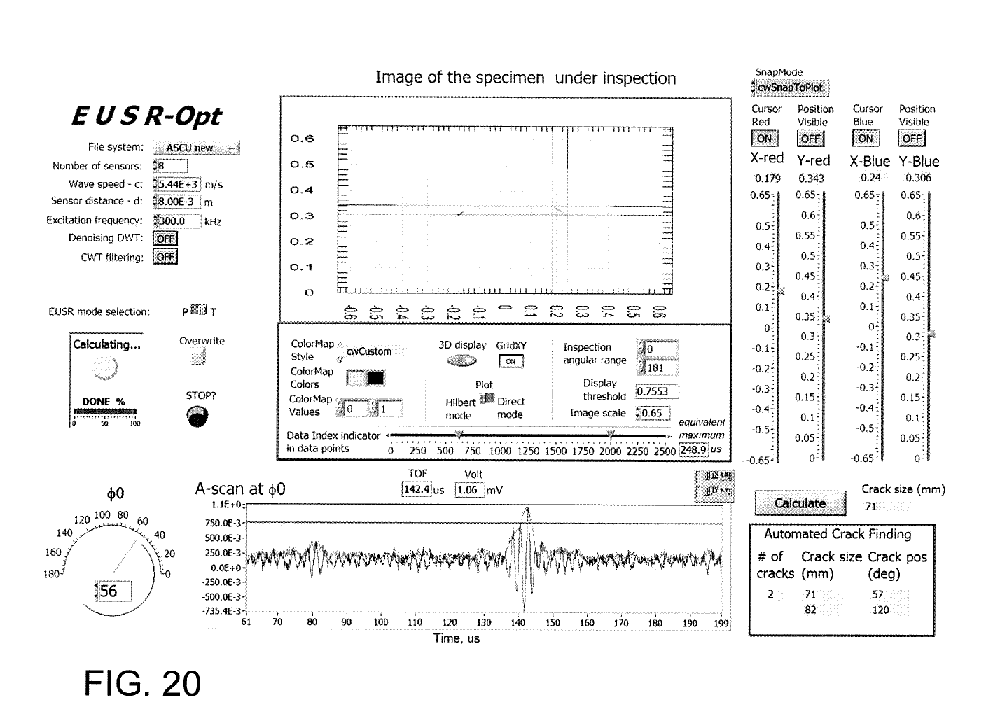

Screen capture of the EUSR-Opt LabVIEW GUI control panel is shown in FIG. 20. New features implemented by advanced signal processing include: 1) denoising via DWT enable; 2) CWT filtering enable; 3) Hilbert transform for envelope extraction; 4) thresholding for removing background noise; 5) TOF measurement via cross correlation; 6) manual crack measurement using the screen cursors; and 7) automated crack finding ability, as indicated in FIG. 20.

After the scanning result is mapped as the EUSR image, two methods are offered for measuring the size of the crack. One is manually measuring the crack by placing two cursors at the ends of the crack and using the distance in between to approximate the real size of the crack. The placements of the cursors are adjusted by dragging the corresponding x and y slides.

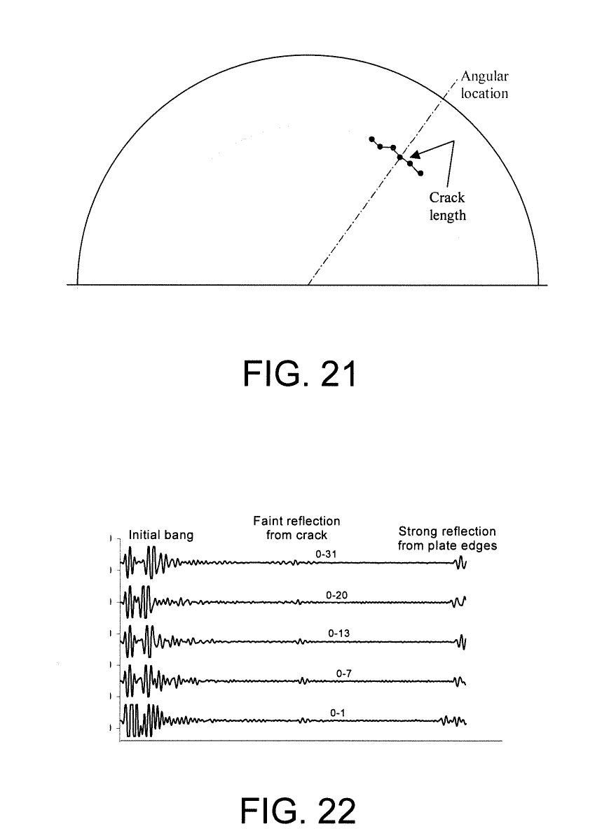

An automated crack finding algorithm is also offered which is dependent on the selection of the thresholding level by the users. The crack finding algorithm will recognize the TOF peaks above the thresholding level, group the continuous points, and identify it (them) as a straight line segment(s). The crack size is approximated by the sum of the length of the neighboring points and the crack location is approximated by the center point in the group. The concept is briefly illustrated in FIG. 21.

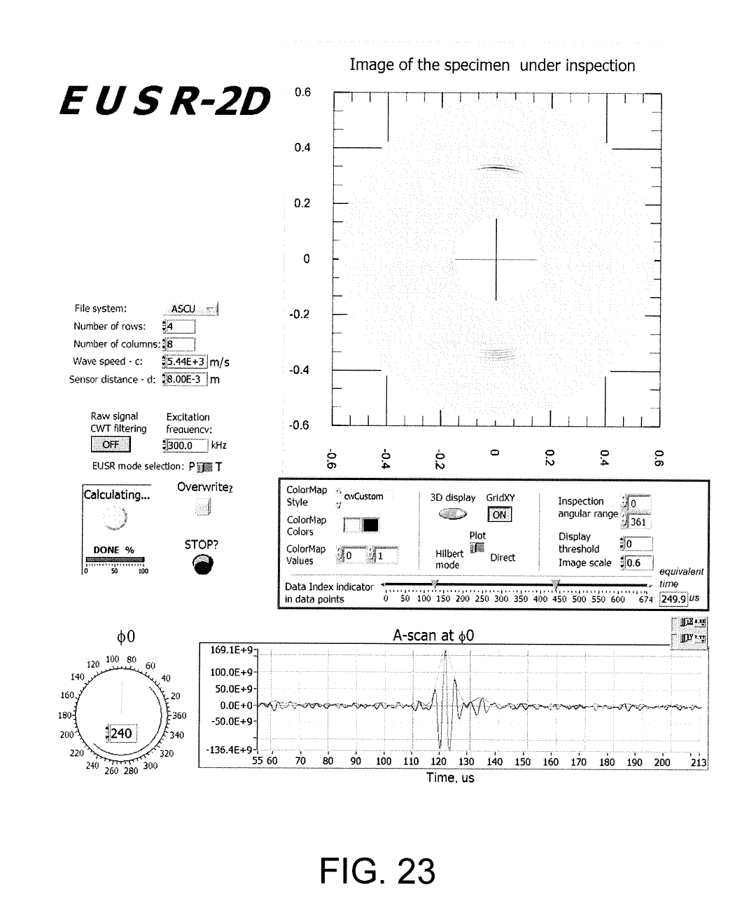

Crack detection using the type I orientation was conducted FIG. 22 shows some signal primitives, pₘₙ(t), where m=0, 1, . . . M−1, n=0, 1, . . . M−1. The signals were obtained from a 4×8 rectangular PWAS array during a broadside detection experiment. They were collected from various receivers when 0^{th} PWAS was used as the transmitter. Present in each signal are the initial bang, a strong reflection from the plate edges, and a faint reflection from the crack. In all the nine signals, a reflection echo due to the simulated crack is present. However, this echo is very faint, and has a very poor signal to noise ratio (SNR). In fact, it is hardly distinguishable from the noise. The LabVIEW GUI control panel is shown in FIG. 23

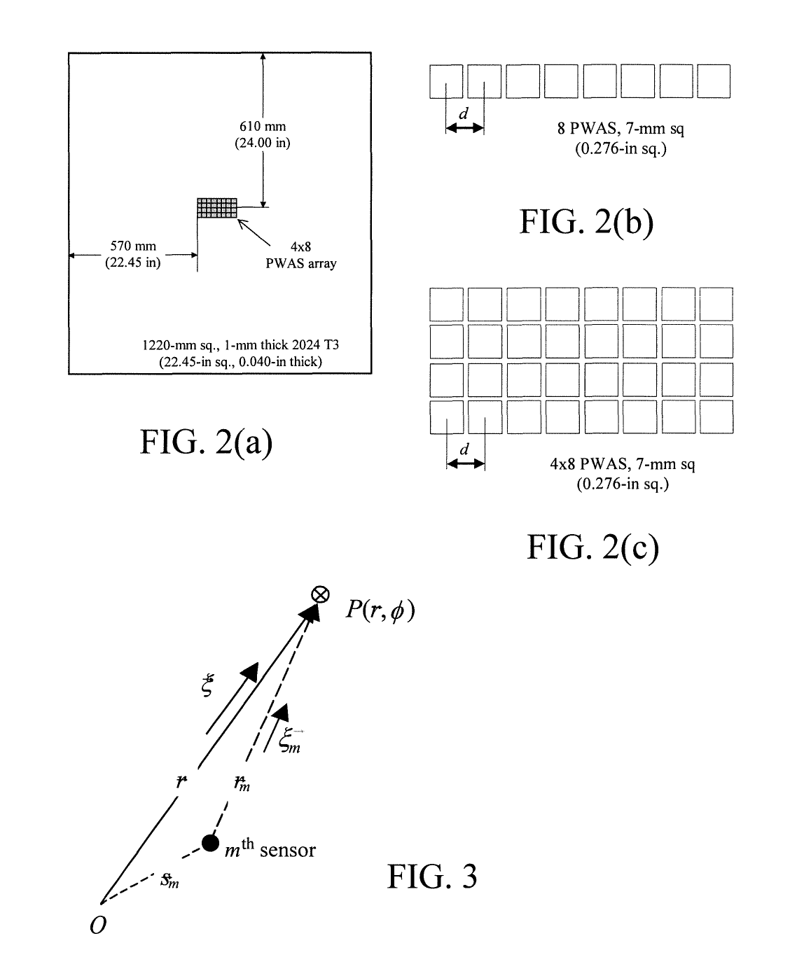

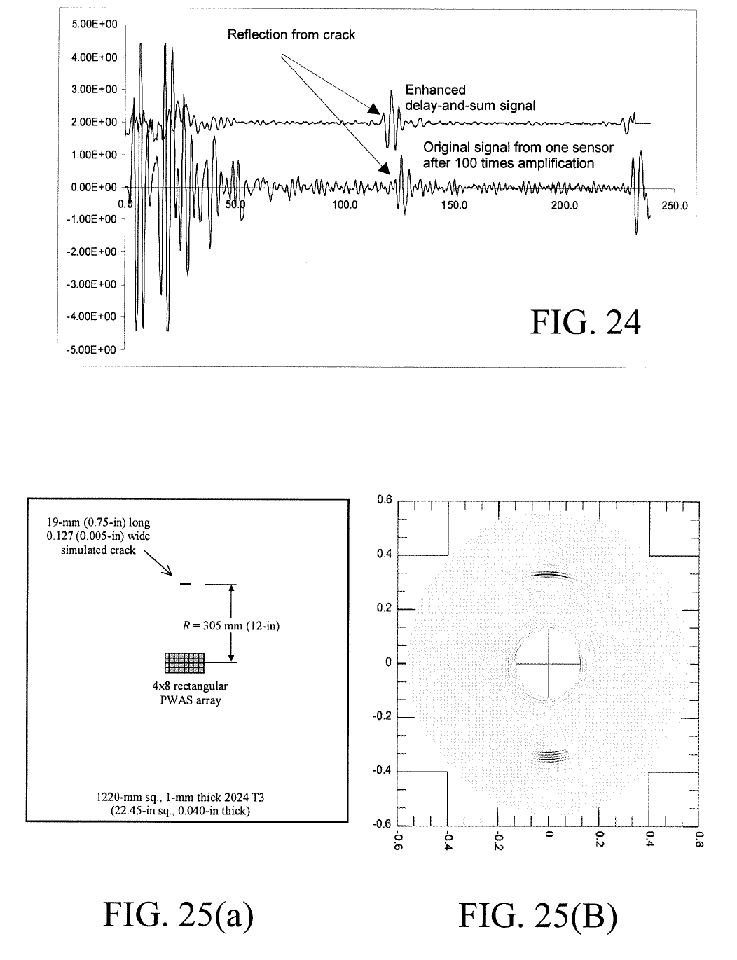

FIG. 24 presents the enhanced signal, s_{R}(t), obtained by the delay-and-sum beamforming of the 4×8 array signals, as described in the present invention (normalized by the crack reflection). The SNR of the enhanced signal is obviously much better. In this enhanced signal, the arrival time of the crack echo can be easily identified as τ_{TOF}=113.1 μs. Using group velocity c_{g}=5.440 mm/μs yields the range of the crack as Rₑₓₚ=307.6 mm. The exact value of the range (FIG. 2(a)) is R=305 mm. The range estimation error is 0.85%. The proposed method has remarkable accuracy.

FIG. 23 presents the front panel of the omnidirectional 2-D embedded ultrasonic structural radar graphical user interface (2-D EUSR-GUI) constructed for this application. The angle sweep is performed automatically to produce the structure/defect imaging picture on the right. Manual sweep of the beam angle can be also performed with the turn knob; the signal reconstructed at a particular beam angle (here, φ₀=90°) is shown in the lower picture of FIG. 23. The crack imaging in the plate using the EUSR method is shown in FIG. 25(b).

FIG. 25(b) presents the results for the preliminary broadside crack experiment using the type I orientation (90° crack detection). Because of the multiple local maxima, multiple shades can be seen which are not preferred for indicating the presence of a single crack. The multiple local maxima are caused by the multiple counts in the original excitation signal. To avoid such a disturbance, an envelope extraction algorithm was developed for obtaining singular local maxima using the Hilbert transform.

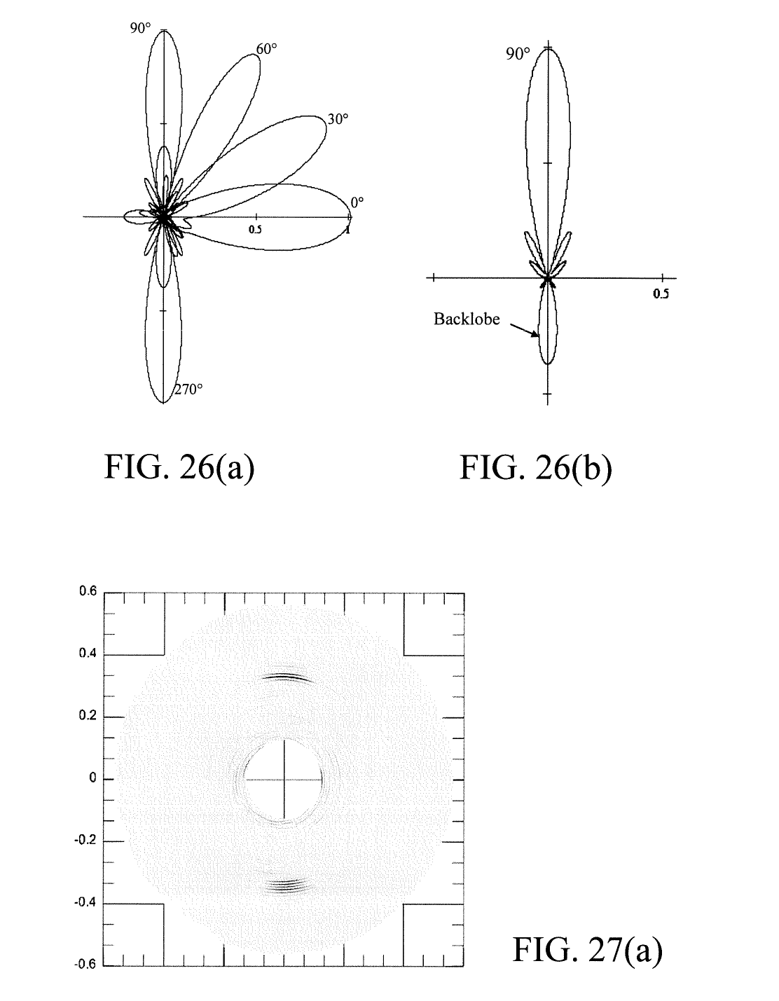

Also, at a location other than the crack presence, a phantom around 270° shows up which is actually caused by the back lobe, as demonstrated by the theoretical beamforming of a 4×8 PWAS array shown in FIG. 26(b). A thresholding process can be introduced to eliminate the influence caused by the back lobe.

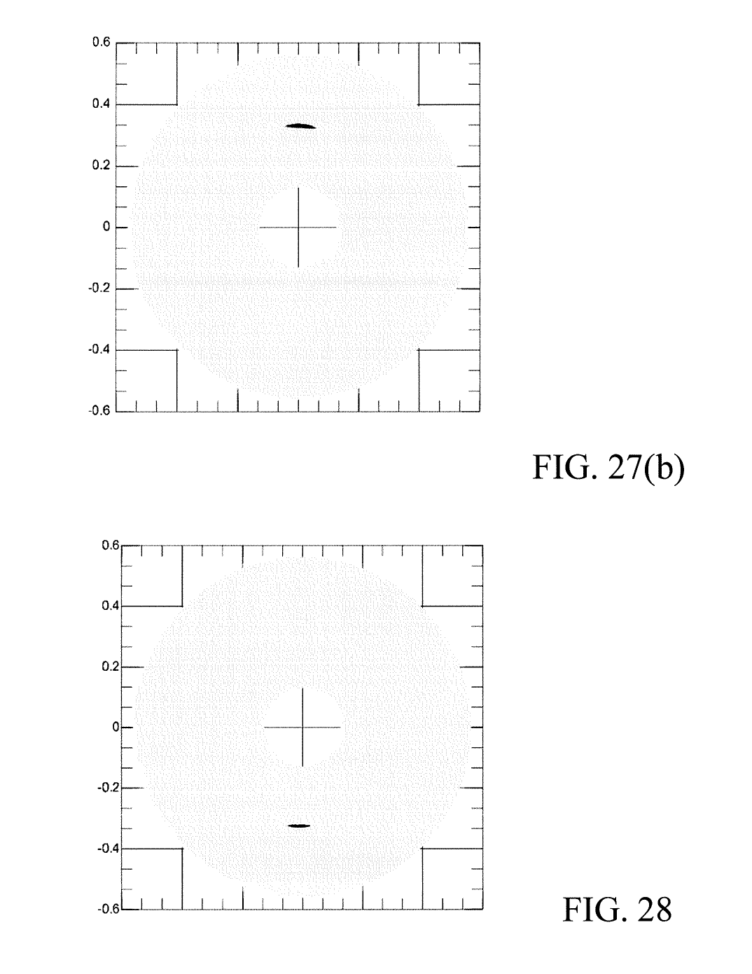

The improved EUSR scanning for the type I orientation is shown in FIG. 27(b). Compared to the original EUSR image illustrated in (FIG. 27(a)), the phantoms caused by the back lobe and background noise have been successfully removed. The previous multiple shadows caused by multiple local peaks were refined to a single shadow correctly representing the presence of a single broadside crack located at 90°.

Further experiment was conducted with the type II orientation. Due to the opposite indexing method, the EUSR PWAS array figured that the crack was “behind” it this time. This successfully verifies that the planar arrays are advantageous over the 1-D arrays because they can recognize any point in a plane.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

### APPENDIX A

[1] Giurgiutiu, V.; Bao, J.; and Zagrai, A.N. (2006) “Structural Health Monitoring System Utilizing Guided Lamb Waves Embedded Ultrasonic Structural Radar”, Pat. No. U.S. 6,996,480 B2, Date of Patent Feb. 7, 2006
[2] Maslak, S. H. (1979) “Phased Array Acoustic Imaging System”, U.S. Pat. No. 4,550,607, Nov. 5, 1979
[3] Stumpf, I. B. (1982) “An investigation of high density phased arrays for ultrasonic contact testing in steel” Ph.D. dissertation, University of Paisley, Scotland, 1982.
[4] Fink, M. (1993) “Time Reversal Mirrors”,a Journal of Physics D: Applied Physics, Vol. 26, 1993, pp. 1333-1350.
[5] Checkovich, P (1998) “Time-Gain Control Sharpens Ultrasound”, Design News, Aug. 3, 1998
[6] Deutsch, W.A.K, Cheng, A.; Achenbach, J. D. (1998) “Defect Detection with Rayleigh and Lamb Waves Generated by a Self-Focusing Phased Array”NDT.net—Dec. 1998, Vol. 3 No. 12
[7] Deutsch, W.A.K, Cheng, A.; Achenbach, J. D. (1999) “Focusing of Rayleigh Waves: Simulation and Experiment”IEEE Transactions of Ultrasonics, Ferroelectrics, and Frequency Control, Vol. 46, No. 2, March 1999, pp. 333-340
[8] Freeman, S. R.; Quick, M. K.; Morin, M. A.; Anderson, R. C.; Desilets, C. S.; Linnenbrink, T. E.; O'Donnell, M. (1999) “Delta-Sigma Oversampling Ultrasound Beamformer with Dynamic Delays” IEEE Transactions of Ultrasonics, Ferroelectrics, and Frequency Control, Vol. 46, No. 2, March 1999, pp. 320-332
[9] Kirk, K. J.; Cornwell, I.; McNab, A.; Cochran, A.; Hayward, G. (1996) “An array-based system for monitoring cracks in industrial plant at high temperatures, “Insight (British. Journal of Non-Destructive Testing), vol. 38, pp. 722{1727, 1996
[10] Kirk, K. J.; McNab, A.; Cochran, A.; Hall, I. Hayward, G. (1999) “Ultrasonic Arrays for Monitoring Cracks in an Industrial Plant at High Temperatures” IEEE Transactions of Ultrasonics, Ferroelectrics, and Frequency Control, Vol. 46, No. 2, March 1999, pp. 311-319
[11] Li, J.; Rose, J. L. (2001) “Implementing Guided Wave Mode Control by Use of a Phased Array Transducer” IEEE Transactions of Ultrasonics, Ferroelectrics, and Frequency Control, Vol. 48, No. 3, May 2001, pp. 761-768
[12] Lines D., Dickson K., “Optimization of High-Frequency Array Technology for Lap-Joint Inspection” ; Proceedings of the 3^{rd} Joint Conference on Aging Aircraft, 1999
[13] Rose, J. L.; Pelts, S. P.; Quarry, M. J. (1998) “A Comb Transducer Model for Guided Wave NDE,” Ultrasonics, Vol. 36 (1998), pp. 163 169
[14]Zhu, W.; Rose, J. L. (1999) “Lamb Wave Generation and Reception with Time-Delay Periodic Linear Arrays: a BEM Simulation and Experimental Study” IEEE Transactions of Ultrasonics, Ferroelectrics, and Frequency Control, Vol. 46, No. 3, pp. 654-664, May 1999
[15] Rose, J. L. (1999) Ultrasonic Waves in Solid Media, Cambridge University Press, 1999
[16]Crawley, E. A. and deLuis, J., (1987) “Use of Piezoelectric Actuators as Elements of Intelligent Structures” AIAA Journal, Vol. 25, No. 10, pp. 1375-1385, 1987.
[17]Keilers, C. H.; Chang, F.-K. (1995) “Identifying Delamination in Composite Beams Using Built-in Piezoelectrics: Part I-Experiments and Analysis; Part II An Identification Method”Journal of Intelligent Material Systems and Structures, Vol. 6, pp. 649-672, September, 1995.
[18] Moetakef, M. A., Joshi, S. P., Lawrence, K. L., (1996) “Elastic Wave Generation by Piezoceramic Patches”AIAA Journal, Vol. 34, No. 1966, pp. 2110-2117.
[19] Zhou, S., Liang, C., and Rogers, C., (1996) “An Impedance-Based System Modeling approach for Induced Strain Actuator-Driven Structures”Journal of Vibration and Acoustics, July 1996, pp.323-331.
[20] Chang, F.-K. (1998) “Manufacturing and Design of Built-in Diagnostics for Composite Structures”52nd Meeting of the Society for Machinery Failure Prevention Technology, Virginia Beach, VA, March 30 —Apr. 3, 1998.
[21] Wang, B., Chen, R., (2000) “The Use of Piezoceramic Transducers for Smart Structural Testing”Proceeding of SPIE 2000 Conference, Newport Beach, CA
[22] Chang, F.-K. (2001) “Structural Health Monitoring: Aerospace Assessment” Aero Mat 2001, 12th ASM Annual Advanced Aerospace Materials and Processes Conference, 12-13 June 2001, Long Beach CA.
[23] Clay, A.C.; Wooh, S.C.; Azar, L.; and Wang, J.Y. (1999) “Experimental Study of Phased Array Beam Steering Characteristics” Journal of Nondestructive Evaluation, Vol. 18, No. 2, 1999, pp. 59˜71
[24] Wooh, S.C. and Shi, Y. (1998) “Influence of Phased Array Element Size on Beam Steering Behavior” Journal of Ultrasonics, Vol. 36, pp. 737˜749
[25] Wooh, S.C. and Shi, Y. (1999) “Optimum Beam Steering of Linear Phased Arrays” Journal of Wave Motion, Vol. 29, 1999, pp. 245˜265
[26]Wooh, S.C. and Shi, Y. (1999) “A Simulation Study of the Beam Steering Characteristics for Linear Phased Arrays” Journal of Nondestructive Evaluation, Vol. 18, No. 2, 1999, pp.39-57
[27] Sundararaman, S. and Adams, D.E. (2002) “Phased Transducer Arrays for Structural Diagnostics Through Beamforming” Proceedings of the 17th Technical Conference of the American for Composites, West Lafayette, IN, Oct. 21˜23, 2002, Paper # 177
[28] Purekar, A.S.; Pines, D.J.; Sundararaman, S.; and Adams, D.E. (2004) “Directional Piezoelectric Phased Array Filters for Detecting Damage in Isotropic Plates” Journal of Smart Materials and Structures, Vol. 13, 2005, pp. 838˜850
[29] Sundararaman, S.; Adams, D.E.; and Rigas, E.J. (2005) “Structural Damage Identification in Homogeneous and Heterogeneous Structures Using Beamforming” Journal of Structural Health Monitoring, Vol. 4(2), 2005, pp. 171˜190 [30] Wilcox, P. (2003) “Omni-directional Guided Wave Transducer Arrays for the Rapid Inspection of Large Areas of Plate Structures” IEEE Transaction on Ultrasonics, Ferroelectrics, and Frequency Control, Vol. 50, No. 6, June 2003, pp. 699
[31 ]Wilcox, P.; Lowe, M.; Cawley, P. (2005) “Omnidirectional Guided Wave Inspection of Large Metallic Plate Structures Using an EMAT Array” IEEE Transactions on Ultrasonics, Ferroelectrics, and Frequency Control, Vol. 52, No. 4, April 2005, pp. 653˜665
[32]Fromme, P.; Wilcox, P.; Lowe, M.; and Cawley, P. (2005) “A Guided Ultrasonic Waves Array For Structural Integrity Monitoring” Quantative Nondestructive Evaluation, Vol. 24, pp. 1780˜1787
[33] Johnson, D.H. and Dudgeon, D.E. (1993), Array Signal Processing. Concepts and Techniques, PTR Prentice Hall, Upper Saddle River, NJ 07458
[34]Balanis, C.A. (2005), Antenna Theory Analysis and Design, 3^{rd} edition, John Wiley & Sons, Inc., Hoboken, N.J.
[35] Shandiz, H. T.; Gaydecki, P. (1999a) “Low Frequency Ultrasonic Images Using Time Domain SAFT in Pitch-Catch Method” NDTnet, Vol. 4, No. 11, November 1999
[36] Shandiz, H. T.; Gaydecki, P. (1999b) “A new SAFT Method in Ultrasonic Imaging at Very Low Frequencies by Using Pulse Echo Method” NDTnet, Vol. 4, No. 11, November 1999
[37]Poularikas, A.D. (Ed.), The Transforms and Applications Handbook (Electrical Engineering Handbook Series), Chapter 10, CRC Press, 2006
[38] Yu, L.; Giurgiutiu, V. (2005) “Advanced Signal Processing for Enhanced Damage Detection with Embedded Ultrasonics Structural Radar using Piezoelectric Wafer Active Sensors”, Smart Structures & Systems—An International Journal of Mechatronics, Sensors, Monitoring, Control, Diagnosis, and Maintenance, Techno-Press, S. Korea, Vol. 1, No. 2, 2005, pp 185-215

What is claimed is:

1. A system for detecting damage features in a thin wall structure, comprising:
a thin wall structure;
a plurality of piezoelectric sensors embedded on said structure;
a generator configured to impress a pulse having a predetermined carrier frequency upon at least one of said sensors to produce guided ultrasonic waves that travel along said thin wall structure; and
a signal processor configured to process received signals at said sensors resulting from an echo from said damage feature,
wherein said processor is configured to implement synthetic beamforming to determining an angular position of at least one damage feature spaced apart from the plurality of sensors along a plane of the thin wall structure, and wherein said processor is further configured to calculate a distance to the damage feature.

2. The system of claim 1, wherein the piezoelectric sensor is a piezoelectric-wafer active sensor.

3. The system of claim 1, wherein the plurality of sensors are embedded on said structure in a random arrangement.

4. The system of claim 1, wherein the plurality of sensors are embedded on said structure in a planar array.

5. The system of claim 1, wherein the plurality of sensors are embedded on said structure in a circular array.

6. The system of claim 5, wherein the circular array corresponds to a plurality of concentric circles.

7. The system of claim 1, wherein said generator is configured to produce a single signal tone burst signal and wherein the tone burst is adjustable in amplitude and repetition rate.

8. The system of claim 1, wherein the generator is configures to selectively energize selected of the plurality of piezoelectric sensors to produce a transmission beam.

9. The system of claim 1, wherein the signal processor is configured to process received signals at said sensors to produce a reception beam.

10. A system for detecting damage features in a thin wall structure, comprising:
a thin wall structure;
a plurality of piezoelectric sensors embedded on said structure in a pattern;
a generator configured to impress a pulse having a predetermined carrier frequency upon said sensors so as to produce guided ultrasonic waves that travel along said thin wall structure at a predetermined azimuth; and
a signal processor configured to process received signals at said sensors resulting from an echo from said damage feature,
wherein said damage feature is spaced apart from the sensors along a plane of the thin wall structure, and wherein the processor is configured to calculate a distance to the damage feature.

11. The system of claim 10, wherein the piezoelectric sensors are piezoelectric wafer active transducers arranged in a random pattern.

12. The system of claim 10, wherein the piezoelectric sensors are piezoelectric wafer active transducers are arranged in a two-dimensional pattern, whereby detection of structural defects over a 360 degree azimuthal sweep may be maximized.

13. The system of claim 10, wherein the piezoelectric sensors are arranged in a circular pattern.

14. The system of claim 13, wherein the circular pattern comprises a plurality of concentric circles.

15. A method for detecting damage features in a thin wall structure, comprising:
embedding a plurality of sensors on a thin wall structure;
impressing a pulse having a predetermined carrier frequency upon at least one of the sensors to produce guided ultrasonic waves that travel along said thin wall structure; and
processing echo signals received at the sensors to implement synthetic beamforming to detect an angular position of at least one damage feature.

16. The method of claim 15, further comprising calculating a distance to the damage feature.

17. The method of claim 15, wherein embedding a plurality of sensors comprises embedding a plurality of piezoelectric-wafer active sensor.

18. The method of claim 15, wherein embedding a plurality of sensors comprises embedding a plurality of sensors on said structure in a planar array.

19. The method of claim 15, wherein embedding a plurality of sensors comprises embedding a plurality of sensors on said structure in a circular array.

20. The method of claim 15, wherein embedding a plurality of sensors comprises embedding a plurality of sensors on said arranged as a plurality of concentric circles.
